(19) United States
(12) Patent Application Publication
(10) Pub. No.: US 2025/0103020 A1
(43) Pub. Date: Mar. 27, 2025

(54) KINETIC-POLES ANGULAR CO-ORDINATES POSITIONING SYSTEM

(71) Applicant: Prasad Herur VENKATESHA MURTHY, Bangalore (IN)

(72) Inventor: Prasad Herur VENKATESHA MURTHY, Bangalore (IN)

(21) Appl. No.: 18/839,846

(22) PCT Filed: Dec. 29, 2021
(86) PCT No.: PCT/IN2021/051215

§ 371 Date: Aug. 20, 2024

(30) Foreign Application Priority Data
Nov. 17, 2021 (IN) 202141052764

(51) Int. Cl. G05B 19/402

(52) U.S. Cl. CPC G05B 19/402; G05B 2219/45041

(57) ABSTRACT

A co-ordinates system used to express the location of a point-on-a-plane with a set of two variables in a two-dimensional (2D) system or a point-in-space with a set of three variables in a three-dimensional (3D) system. Both the two-dimensional (2D) and the three-dimensional (3D) KPACS of the present invention offer several advantages over other linear and quasi-linear co-ordinates systems such as Cartesian co-ordinates systems, polar co-ordinates systems, and spherical co-ordinates systems.

### FIELD OF THE INVENTION

This Invention is a New and Unique Co-ordinates System titled KINETIC-POLES ANGULAR CO-ORDINATES POSITIONING SYSTEM which would find many Mathematical, Scientific and Engineering Applications.

### BACKGROUND OF THE INVENTION

Co-ordinates Systems are used to express the location of a Point-On-A-Plane with a set of two variables in a 2-Dimensional System or a Point-In-Space with a set of three variables in a 3-Dimensional System. There exist several different Co-ordinates Systems, proposed by renowned Mathematicians and Scientists and popularly accepted and used in various Applications, each one achieving the intended results by using a different method. Some of the existing Co-ordinates Systems and their brief explanations are as under.

### Cartesian Co-Ordinates System

A Linear Co-ordinates System to express the location of a Point-On-A-Plane with a set of 2 linear distances along the X Axis and the Y Axis, represented as (x,y) in a 2-Dimensional System or to express the location of a Point-In-Space with a set of 3 linear distances along the X Axis, the Y Axis and the Z Axis, represented as (x,y,z) in a 3-Dimensional System, the distances being measured from the Origin located at the Centre of the Co-ordinates System.

Cartesian Co-ordinates are the foundation of analytic geometry, and provide enlightening geometric interpretations for many other branches of mathematics, such as linear algebra, complex analysis, differential geometry, multivariate calculus, group theory and more. A familiar example is the concept of the graph of a function. Cartesian Co-ordinates are also essential tools for most applied disciplines that deal with geometry, including astronomy, physics, engineering and many more. They are the most common coordinate system used in computer graphics, computer-aided geometric design and other geometry-related data processing.

### Polar Co-Ordinates System

A 2-Dimensional Co-ordinates System to express the location of a Point-On-A-Plane with a set of 2 parameters namely, the linear distance of the location from reference point and the angle of the location from a reference direction, represented as (r, φ).

Polar Co-ordinates are most appropriate in any context where the phenomenon being considered is inherently tied to direction and length from a Centre point in a plane, such as spirals. Planar physical systems with bodies moving around a central point, or phenomena originating from a central point, are often simpler and more intuitive to model using Polar Co-ordinates.

### Spherical Co-Ordinates System

Spherical Co-ordinates System is an extension of the 2-Dimensional Polar Co-ordinates System to a 3-Dimensional Co-ordinates System, where location of a Point-In-Space is expressed with a set of 3 parameters namely, the linear distance of the location from a reference point, the angle measured from a fixed zenith direction, and the angle of its orthogonal projection on a reference plane that passes through the reference point and is orthogonal to the zenith, measured from a fixed reference direction on that plane, represented as (r,θ, φ).

### KINETIC-POLES ANGULAR CO-ORDINATES SYSTEM

Kinetic-Poles Angular Co-ordinates System, hereinafter referred to as KPACS, is a new and unique Co-ordinates System Invented by the Inventor. As is evident from the title, KPACS is an Angular Co-ordinates System, in which the location of a Point-On-A-Plane is expressed with a set of 2 Angles, the Primary Angle and the Secondary Angle, represented as (αP, αS) in a 2-Dimensional System and the location of a Point-In-Space is expressed with a set of 3 angles, the Primary Angle, the Secondary Angle and the Tertiary Angle, represented as (αP, αS, αT) in a 3-Dimensional System.

The core of KPACS is made up of a set of Kinetic Poles Integrated in a desirable manner, along with the Kinetic Forces exerted by them and the Effects of these Kinetic Forces. The term Kinetic-Poles is intended to mean that these Poles are Active or Dynamic in the sense that they are capable of rotational motion unlike the Poles in the case of Polar Co-ordinates System, which are passive or static. Hence KPACS is a Kinetic System.

### 2-Dimensional KPACS

2-Dimensional KPACS comprises of 2 Kinetic Poles, the Primary Kinetic Pole and the Secondary Kinetic Pole, Integrated on the Plane-Of-Interest in a Desirable Manner along with the Kinetic Forces exerted by them and the effects of these Kinetic Forces.

FIG. 1 illustrates the Theoretical Model of a 2-Dimensional KPACS Integrated on a Circular Plane-Of-Interest with an Angular Grid.

FIG. 2 illustrates the Functioning of the 2-Dimensional KPACS. The Primary Kinetic Pole, P is located at the Centre (Origin) of KPACS and is capable of Bi-Directional Rotational Motion about its Rotational Axis and along the 2-Dimensional Plane-Of-Interest which is Perpendicular to the Rotational Axis of P. The Rotational Motion of the Primary Kinetic Pole P is measured as Primary Angular Position αP with reference to the Primary Angular Reference αP0, the Angular Home of Primary Kinetic Pole P.αP0 is always located at 0° of KPACS, where αP=0°. Value of QP can be any Real Number such that −360°>=αP=<+360°.

The Primary Kinetic Pole is capable of exerting a Binding Kinetic Force FP of Constant Magnitude mP on the Secondary Kinetic Pole in the direction of the Angular Position αP. Hence, FP acts along 0° of KPACS when αP=αP0=0°.

The Secondary Kinetic Pole, S is located at the end of the Binding Kinetic Force FP which acts upon the Secondary Kinetic Pole S in a way that results in the Secondary Kinetic Pole S to Orbit Around the Primary Kinetic Pole P at a Radial Distance equal to mP, as P rotates about its Rotational Axis. Hence, the location of Secondary Kinetic Pole S, unlike that of Primary Kinetic Pole P, is not fixed, but changes based on αP, the Angular Position of P. The location of Secondary Kinetic Pole S can be expressed in Polar Co-ordinates (mP, αP).

Note that the Secondary Kinetic Pole always lies on the Circle with its Centre at the Centre of the 2-Dimensional KPACS and Radius=mP, the Magnitude of the Primary Kinetic Force FP.

The Secondary Kinetic Pole S is also capable of Bi-directional Rotational Motion about its Rotational Axis and along the 2-Dimensional Plane-Of-Interest which is Perpendicular to the Rotational Axis of Secondary Kinetic Pole S. The Rotational Motion of S is measured as Angular Position αS with reference to the Secondary Angular Reference αS0, the Angular Home of Secondary Kinetic Pole S. αS0 is always located at the Angular Position αP of the Primary Kinetic Pole P. If αP=0° and αS=0°, then αS0 lies along 0° of KPACS. Value of αS can be any Real Number such that −360°>=αS=<+360°.

The Secondary Kinetic Pole S is again capable of exerting a Binding Kinetic Force FS of Constant Magnitude mS (=mP) on the Locus L, but of variable direction which is equal to the Angular Position αS. Hence, FS acts along 0° of KPACS when αP=αP0=0° and αS=αS0=0°, which means that both the Primary Kinetic Pole P as well as the Secondary Kinetic Pole S are at their respective Angular References. In the Theoretical Model, the condition mS=mP is essential for the working of KPACS.

The Locus L, which is our Point-Of-Interest, is located at the end of the Binding Kinetic Force FS which acts upon L in a way which results in L to Orbit Around the Secondary Kinetic Pole S at a Radial Distance equal to mS as the Secondary Kinetic Pole S rotates about its Rotational Axis. Hence, the location of Locus L changes based on the Angular Positions αP as well as αS. The location of Locus L can be expressed as the Angular Pair (αP,αS).

It is primarily this Native Core Behaviour of the manner of Integration of the Primary Kinetic Pole P and the Secondary Kinetic Pole S along with their respective Kinetic Forces FP and FS and the effects of these Kinetic Forces that results in the 2-Dimensional KPACS, where every Point within the boundary of 2-Dimensional KPACS can be expressed as the Angular Pair (αP,αS).

### Proof and Examples of 2-Dimensional KPACS can be found In Appendix-A

### Core Characteristics Of 2-Dimensional KPACS

Following are some Core Characteristics of 2-Dimensional KPACS.

### Endless System

2-Dimensional KPACS is a Circular Endless System due to 360° Bi-Directional Rotational Motion of its Poles, namely the Primary Kinetic Pole P and the Secondary Kinetic Pole S, where there is no limit to the Extent of Motion of these Components, unlike such as in Linear or Quasi-Linear Systems such as Cartesian Co-ordinates System or Polar Co-ordinates System or Spherical Co-ordinates System. This property of 2-Dimensional KPACS results in many Advantages.

### Non-Linear System

Since 2-Dimensional KPACS achieves the desired result merely through Rotational Motion of its Components, it is a Non Linear System and does not require conversion of Rotational Motion to Linear Motion, unlike such as in Linear or Quasi-Linear Systems such as Cartesian Co-ordinates System or Polar Co-ordinates System or Spherical Co-ordinates System. This property of 2-Dimensional KPACS results in many Advantages.

### Alternate Angular Pair

FIG. 4 illustrates the Alternate Angular Pair of 2-Dimensional KPACS. Referring to FIG. 4, it is derived that the Angular Position of the Secondary Kinetic Pole with reference to 0°, the Positive X Direction of 2-Dimensional KPACS, is given by the equation:

$$α 0 S = ∠ LPV α P 0 - ∠ SPL$$

The Angular Pair (αP,αS) yields an Alternate Angular Pair (αP!,αS!) Symmetrical about the Line PL as demonstrated in FIG. 4 such that:

$$( α P ! , α S ! ) = ( α 0 S , - α S )$$

The aforesaid Core Characteristics of 2-Dimensional KPACS yield many Advantages as discussed later in this Specification.

### 3-Dimensional KPACS

3-Dimensional KPACS comprises of 3 Kinetic Poles, the Primary Kinetic Pole, the Secondary Kinetic Pole and the Tertiary Kinetic Pole, Integrated in a desirable manner along with the Kinetic Forces exerted by it and the effects of these Kinetic.

FIG. 13 illustrates the Theoretical Model of a 3-Dimensional KPACS shown on an Angular Grid. As illustrated, the 3-Dimensional KPACS is derived by Integrating the 3rd Dimensional Kinetic Pole T and its Kinetic Forces and the effects of these Kinetic Forces with a complete 2-Dimensional KPACS in a manner where the Centre of the 2-Dimensional KPACS and the Centre of the 3-Dimensional KPACS lie at the same point which is also the Origin of the 3-Dimensional KPACS and the Tertiary Kinetic Pole T is located Perpendicular to the Primary Kinetic Pole P such that, the Rotational Axis of the Primary Kinetic Pole P and the Rotational Axis of the Tertiary Kinetic Pole T are Perpendicular to each other and Intersect with each other at the Origin of the 3-Dimensional KPACS and also the Tertiary Kinetic Force FT acts as a Binding Force on the 2-Dimensional KPACS such that whenever the Tertiary Kinetic Pole T rotates about its Rotational Axis, it results in the 2-Dimensional KPACS also to rotate about the Rotational Axis of the Tertiary Kinetic Pole T.

Hence, as the Angular Position of the Tertiary Kinetic Pole T changes from its Home Position, it results in the 2-Dimensional KPACS to turn about its 0° by a value equal to the Angular Position &T of the Tertiary Kinetic Pole T from its Home Position. Value of αT can be any Real Number such that −360°>=αT=<+360°.

Whereas the Boundary of the 2-Dimensional KPACS is a Circular Plane, the Integration of the 3rd Dimensional Kinetic Pole T with the 2-Dimensional KPACS yields the Spherical Spatial Boundary of the 3-Dimensional KPACS. The Radius of the Spherical Spatial Boundary of the 3-Dimensional KPACS is equal to mT, the Magnitude of the Tertiary Kinetic Force FT, which is equal to the Sum of mP, the Magnitude of the Primary Kinetic Force FP, and mS, the Magnitude of the Secondary Kinetic Force FS.

### Proof and Examples of 3-Dimensional KPACS of can be Found in Appendix-B

### Core Characteristics of 3-Dimensional KPACS

Similar to the 2-Dimensional KPACS, the 3-Dimensional KPACS too possesses following Core Characteristics:

### Endless System

3-Dimensional KPACS is a Spherical Endless System due to 360° Bi-Directional Rotational Motion of its Poles, namely the Primary Kinetic Pole P, the Secondary Kinetic Pole S and the Tertiary Kinetic Pole T, where there is no limit to the Extent of Motion of these Poles, unlike such as in Linear or Quasi-Linear Systems such as Cartesian Co-ordinates System or Polar Co-ordinates System or Spherical Co-ordinates System. This property of 2-Dimensional KPACS results in many Advantages.

### Non-Linear System

Since the 3-Dimensional KPACS achieves the desired result merely through Rotational Motion of its Components, it is a Non Linear System and does not require conversion of Rotational Motion to Linear Motion, unlike such as in Linear or Quasi-Linear Systems such as Cartesian Co-ordinates System or Polar Co-ordinates System or Spherical Co-ordinates System. This property of 3-Dimensional KPACS results in many Advantages.

### Alternate Angular Set

The Angular Set (αP,αS,αT) yields an Alternate Angular Set (αP!,αS!,αT!) Symmetrical about the Line PL such that:

$$( α P ! , α S ! , α T ! ) = ( α0 S , - α S , - α T )$$

The aforesaid Core Characteristics of 3-Dimensional KPACS yield many Advantages as discussed later in this Specification.

### Discussion of Prior Art

WO2007084911A2 describes methods and devices for determining position and/or angular orientation of a rotating shaft (112). Exemplary features include sensor module (120/340) and position determination module (335). Sensor module (120/340) may include Hall Effect Devices (222/224) arranged at a specified angular separation (230) to produce a signal in response to rotation of shaft (112). Position module (335) may be responsive to sensor module (120/340) to produce a converted signal, determine an error term, and produce a position estimate. Converted signal may be produced by processing Hall Effect Device signals into sinusoidal reference signals having offset scale (415/435) and amplitude scale (420/440) factors. Error term may be determined by processing the converted signals to produce an estimated position signal. Position estimate may be produced by processing the error term. Refined position measurement may be achieved by iterative elimination of regressive differences between position estimates with minimization of absolute magnitude of error term.

WO2003047068A1 discloses a Ring mode starter/generator wherein a kind of ring mode starter/generator includes two parts, ring-shaped stator (I) and ring-shaped rotor (2 or 3), and a set of low power heavy current converting controller. The ring-shaped stator (1) is installed on the engine or the cover of the water pump. Meanwhile the ring-shaped rotor (2 or 3) is installed on the rotating flywheel of the engine or on the rotating wheel of the water pump. A new structure of mechanism and generator system is composed through utilizing the mechanism of the engine or the water pump, such as the rotating shaft, bearing, cover, etc., so that the generator rotates coaxially with the engine or the water pump and is driven directly. This ring mode starter/generator results in simplifying the traditional generator structure and mechanical driving mode of automobile, combining the generator and the engine or the water pump more reasonably and compactly, achieving a high efficiency structure of mechanism and generator system, and enhancing the actuation reliability and working efficiency of the generator to the utmost extent. It also has features of dispensing with heat-away device, low working temperature, high power, high working efficiency, high driving moment, etc.

U.S. Pat. No. 6,231,011B1 a torque/reactive momentum wheel control system for use in satellites for dynamic attitude maintenance and alteration where the flywheel of each momentum wheel is levitated by a high-temperature superconducting element repulsively interacting with permanent magnets in the flywheel. The spin rate (rpm) of the flywheel being controlled by either an active magneto or electromagneto drive system. Each momentum wheel is cooled by a cryo-cooler and can have a total weight of about 10 Kg to a fraction of 1 Kg and delivering 3.5 Js with less than 1 W loss.

WO2005119886A2 discloses an Axial-flux, permanent magnet electrical machine wherein an axial flux, permanent magnet electrical machine is disclosed. The machine has at least one stator disc (12) and at least one rotor disc (10) co-axial with the stator disc and mounted for rotation relative to the stator disc. The rotor has a plurality of permanent magnets (18) mounted circumferentially thereon, and the stator comprises a plurality of discrete windings (24). The windings are recessed in the stator. The stator disc can be formed from a plastics material, and the rotor can have a segmented construction. The windings can also be arranged in groups to provide for a multi-phase machine.

### Summary Of Invention

Both 2-Dimensional and 3-Dimensional KPACS offer several advantages over other Linear and Quasi-Linear Co-ordinates Systems such as Cartesian Co-ordinates System, Polar Co-ordinates System and Spherical Co-ordinates System in Several Engineering Applications Domains. These Advantages of KPACS which stem from the Core Characteristics of 2-Dimensional and 3-Dimensional KPACS are as described as follows.

### KINETIC-POLES ANGULAR CO-ORDINATES POSITIONING SYSTEMS

Kinetic-Poles Angular Co-ordinates Positioning Systems (hereinafter referred to as KPACPS), Invented by the Inventor, are 2-Dimensional (XY) and 3-Dimentional (XYZ) Positioning Systems realized from 2-Dimensional KPACS and 3-Dimensional KPACS.

### Advantages of KPACPS

Both 2-Dimensional and 3-Dimensional KPACPS offer several advantages over Positioning Systems derived from other Linear and Quasi-Linear Co-ordinates Systems such as Cartesian Co-ordinates System, Polar Co-ordinates System and Spherical Co-ordinates System in Several Engineering Applications Domains where Precise Positioning of Work Tools and Parts are necessitated. These Advantages of KPACPS which stem from the Core Characteristics of 2-Dimensional and 3-Dimensional KPACS are as described here under:

Endless System: The 2-Dimensional KPACS is a Circular Endless System and the 3-Dimensional KPACS is a Spherical Endless System due to 360° Bi-Directional Rotational Motion of their Poles P, S and T, where there is no limit to the Extent of Motion of these Poles, unlike such as in Linear or Quasi-Linear Systems.

Non-Linear System: Since both 2-Dimensional KPACS and 3-Dimensional KPACS achieve the desired results merely through Bi-Directional Rotational Motion of their Poles P, S and T, they are Non-Linear Systems and do not require conversion of Rotational Motion to Linear Motion, unlike such as in Linear or Quasi-Linear Systems such as Cartesian Co-ordinate, Polar Co-ordinate or Spherical Co-ordinates Systems.

Alternate Angular Set: The 2-Dimensional KPACS yields an Alternate Angular Pair while the 3-Dimensional yields an Alternate Angular Set Symmetrical about the Line from the Centre of the System to the Locus.

The above Core Characteristics of KPACS result in many Advantages over Linear or Quasi-Linear Systems such as Cartesian Co-ordinate or Polar Co-ordinate or Spherical Co-ordinates Systems when Adapted for Realising Practical Applications.

When both 2-Dimensional KPACS and 3-Dimensional KPACS are adapted for Realizing Practical Applications, such as 2-Dimensional and 3-Dimensional Positioning Systems, their Poles P, S and T would be replaced by Suitable Motors such as Stepper or Servo Motors as described earlier. Considering functioning of such Practical Applications, the Advantages of KPACPS as compared to either Cartesian or Polar or Spherical Co-ordinates Systems can be derived as follows:

### KPACPS Yields Higher Work Efficiency

It is clearly seen that, while Seeking any given location within the KPACS Boundary, which amounts to the Work Done, each Motor Shaft may have to Turn a Maximum of 360° or 1 Rotation from its Current Position, as against the same Application Realised by adapting Cartesian or Polar or Spherical Co-ordinates System, where the Motor Shafts may have to Turn Several Rotations, which amounts to More Work Done for the Same Result. This means that KPACPS Yields Higher Work Efficiency due to Lesser Work Done, which results in many Advantages as compared to other Linear and Quasi-Linear Systems as listed under:

### Less Work Done for the Same Results

Higher Performance of Motors due to Lesser Work Done for the Same Results Higher Performance of other Sub-Systems due to Lesser Work Done for Same Results Higher Longevity of the System due to Lesser Work Done for the Same Results Lesser Power Consumption due to Lesser Work Done for the Same Results

### KPACPS Yields Higher Time Efficiency

Lesser Extent of Motion of Motors in KPACPS Applications to achieve the Same Results leads to Reduction in Location Seek Time. Further, since the Rotational Motion of Motor Shafts is Bi-directional, seeking a Location can occur by adapting the Rotational Direction which results in further Reduction in Location Seek Time.

Further, due to the Property of Alternate Angular Pair of 2-Dimensional KPACS and Alternate Angular Set of 3-Dimensional KPACS, Seeking a Location can occur by adapting the Angular Pair in 2-Dimensional KPACS or Angular Set in 3-Dimensional KPACS, which would result in further Reduction in Location Seek Time.

Thus, it is clear that KPACS Yields Higher Time Efficiency, which results in many Advantages as compared to other Linear and Quasi-Linear Systems as listed under:
Shorter Time Taken for the Same Work Done due to Shorter Location Seek Time
Higher Productivity for the Same Work Done due to Shorter Location Seek Time

### KPACPS Yields Higher Positioning Accuracy

Positioning Systems Applications derived from Cartesian, Polar and Spherical Co-ordinates Systems, being Linear and Quasi-Linear Systems will have to employ various methods of Motion Conversion to convert Rotational Motion of Motor Shafts to Linear Motion, such as a Pinion and Belt Set or a Pinion and Screw Rod Set etc. As we know, any method of Motion Conversion has Losses and Inaccuracies associated with them, leading to Positioning Errors, which become cumulative over several consecutive Location Seek Moves. KPACPS, being a Non-Linear System, achieves Location Seek Moves merely through Rotational Motion of its Motor Shafts, thereby entirely eliminating the necessity of any Motion Conversion at all, which results in elimination of Motion Conversion Losses and Errors completely and thus Yields Higher Positioning Accuracy.

### KPACPS Yields Extreme Performance

By further Adapting Quad Work Tool Model, as described later in this Specification, to Specific Practical Applications, Productivity can be increased by 4 times. Considering all the above Advantages offered by KPACPS, it can be claimed that KPACPS-Derived Practical Systems Yield Extreme Performance.

### Applications of 2-Dimentional and 3-Dimensional KPACPS

KPACPS will find multitude of Mathematical, Scientific and Engineering Applications in many Application Domains. Some of the Engineering Applications of KPACPS are as under

2-Dimensional and 3-Dimensional Positioning Systems: Positioning Systems are very commonly employed where Accurate Positioning is necessitated such as in Manufacturing Machinery including Machining Centres and Positioning Tables for Tool Positioning, Part Positioning etc. and also in Medical Equipment for Scanning. Present day Positioning Systems are based on Linear Co-ordinates Systems.

2-Dimensional and 3-Dimensional KPACPS, with their Advantages over Linear Co-ordinates Systems as discussed earlier, are very ideally suited for implementing any type of Positioning System, especially Manufacturing Robots and Medical Scanning Equipment.

Robotics: Most Robots, especially Industrial Robots, have to address all 3 Dimensions. Present day Robots employ Linear Co-ordinates for Positioning and use various conversion methods to convert Rotational Motion to Linear Motion for the purpose.

2-Dimensional and 3-Dimensional KPACPS, with their Advantages over Linear Co-ordinates Systems as discussed earlier, especially their Unrestricted Endless Bi-Directional Rotational Motion of 360° are very ideally suited for implementing Robots resulting in Simpler Construction, Higher Performance and Higher Efficiency. By further Adapting Quad Work Tool Model, as described earlier, for Specific Applications, Productivity can be increased by 4 times.

3D Printers: As is well known, 3D Printers are very popular in present day Applications for printing 3-Dimensional. Present day 3D Printers are based on Linear Co-ordinates Systems.

3-Dimensional KPACPS, with their Advantages over Linear Co-ordinates Systems as discussed earlier, are very ideally suited for implementing 3D Printers.

Recorders: Recorders are commonly employed in Scientific Applications for plotting 2-Dimensional Graphs from Real Time Data, for example, Seismic Activity and also in Engineering Applications for plotting Real Time Test Data. Present day Recorders are based on Linear Co-ordinates Systems.

2-Dimensional KPACPS, with their Advantages over Linear Co-ordinates Systems as discussed earlier, are very ideally suited for implementing any type of Recording Systems.

Plotters: Plotters are commonly employed in Engineering Applications for plotting 2-Dimensional CAD and Architectural Drawings. Present day Plotters are based on Linear Co-ordinates Systems.

2-Dimensional KPACPS, with their Advantages over Linear Co-ordinates Systems as discussed earlier, are very ideally suited for implementing Plotters.

Scanners: 2-Dimensional Scanners are commonly employed for Scanning Documents, whereas 3-Dimensional Scanners are employed for Scanning 3-Dimensional Parts in Reverse Engineering Applications. Present day Scanners are based on Linear Co-ordinates Systems.

2-Dimensional and 3-Dimensional KPACPS, with their Advantages over Linear Co-ordinates Systems as discussed earlier, are very ideally suited for implementing both Document and Part Scanners.

Co-ordinate Measurement Systems: Co-ordinate Measurement Systems are 3-Dimensional Systems employed for Scanning 3-Dimensional Parts in Reverse Engineering Applications. Present day Co-ordinate Measurement Systems are based on Linear Co-ordinates Systems.

3-Dimensional KPACPS, with their Advantages over Linear Co-ordinates Systems as discussed earlier, are very ideally suited for implementing Co-ordinate Measurement Systems.

Laser Applications: 2-Dimensional and 3-Dimensional KPACPS can be well adapted for Laser Applications in Manufacturing including

Laser Marking Machines

Laser Cutting Machines

Laser Welding Machines

Works In Progress Regarding KPACPS

Following are some Key Works in Progress regarding KPACPS:

KPACPS Engine

KPACS Engine is a Fully Integrated, High Precision, Highly Robust and Highly Reliable System based on KPACS in both 2-Dimensional and 3-Dimensional Models, which can be Readily Adapted to any Practical Application requiring Numerically Controlled 2-Dimensional and 3-Dimensional Positioning. Presently, Work is in Progress on Design, Development and Build of KPACPS Engine.

Prototyping of Practical Application Of 3-Dimensional KPACPS

Presently, Work is in Progress on Design, Development and Build of a Working Prototype of 3-Dimensional KPACPS.

Better Design and Build Of Practical Models of KPACPS

Presently, Work is in Progress on Design, Development and Build of a More Efficient and Robust Versions of Working Prototypes of Applications based on Variants of the Typical Practical Model of KPACPS as presented earlier.

Application Software Platform for KPACPS

Presently, Work is in Progress on Design, Development and Build of a High Performance Application Software Platform for KPACPS.

### DETAILED DESCRIPTION OF THE PREFERRED EMBODYMENTS

Following is a detailed description of the preferred embodiments of this Specification.

### BRIEF DESCRIPTION OF FIGURES

FIG. 1—Illustration of Theoretical Model of 2-Dimensional KPACS Integrated on a Circular Plane-Of-Interest with an Angular Grid.

FIG. 2—Illustration of Functioning of 2-Dimentional KPACS.

FIG. 3—Active Block of FIG. 2 for easy Assimilation.

FIG. 4—Illustration of Alternate Angular Pair of 2-Dimensional KPACS.

FIG. 5—Example 1 of 2-Dimensional KPACS-Illustration of Locus L of 2-Dimensional KPACS located in the 1^{st} Quadrant of the 2-Dimensional Cartesian Co-ordinates System.

FIG. 6—Example 2 of 2-Dimensional KPACS-Illustration of Locus L of 2-Dimensional KPACS located in the 2^{nd} Quadrant of the 2-Dimensional Cartesian Co-ordinates System.

FIG. 7—Example 3 of 2-Dimensional KPACS-Illustration of Locus L of 2-Dimensional KPACS located in the 3^{rd} Quadrant of the 2-Dimensional Cartesian Co-ordinates System.

FIG. 8—Example 4 of 2-Dimensional KPACS-Illustration of Locus L of 2-Dimensional KPACS located in the 4^{th} Quadrant of the 2-Dimensional Cartesian Co-ordinates System.

FIG. 9—Illustration of Alternate Angular Pair of 2-Dimensional KPACS Symmetrical along the Line PL for Example 1 of 2-Dimensional KPACS.

FIG. 10—Illustration of Alternate Angular Pair of 2-Dimensional KPACS Symmetrical along the Line PL for Example 2 of 2-Dimensional KPACS.

FIG. 11—Illustration of Alternate Angular Pair of 2-Dimensional KPACS Symmetrical along the Line PL for Example 3 of 2-Dimensional KPACS.

FIG. 12—Illustration of Alternate Angular Pair of 2-Dimensional KPACS Symmetrical along the Line PL for Example 4 of 2-Dimensional KPACS.

FIG. 13—Illustration of Theoretical Model of 3-Dimensional KPACS shown on Angular Grid.

FIG. 14—Illustration of First Quadrant of the 3-Dimensional KPACS with 2 Loci.

FIG. 15—Example of 3-Dimensional KPACS-Illustration of how the 2-Dimensional KPACS Plane of the 3-Dimensional KPACS turns around its 0° by an Angle which is equal to ·T.

FIG. 16—KPACS Demo demonstrating Initial State in which both Primary Kinetic Pole P and Secondary Kinetic Pole S are at their respective Home Positions where αP=0° and αS=0°.

FIG. 17—KPACS Demo demonstrating Function ‘TurnPrimary’ with (αP,αS)=(67.23°,0°). Resulting (X,Y)=(3.876, 9.218).

FIG. 18—KPACS Demo demonstrating Function ‘TurnPrimary’ with (αP,αS)=(−114.89°,0°). Resulting (X,Y)=(−4.204,−9.074).

FIG. 19—KPACS Demo demonstrating Function ‘TurnPrimary’ and ‘TurnSecondary’ with (αP,αS)=(−163.94°,−118.56°). Resulting (X,Y)=(−1.294,4.94).

FIG. 20—KPACS Demo demonstrating Function ‘TurnPrimary’ and ‘TurnSecondary’ with (αP,αS)=) (−128.67°,−62.39°. Resulting (X,Y)=(−2.454,1.052).

FIG. 21—KPACS Demo demonstrating Function ‘TurnPriSec’ with (αP,αS)=(45°,−67.417°). Resulting (X,Y)=(8.157,1.6288).

FIG. 22—KPACS Demo demonstrating Function ‘TurnPriSec’ with (αP,αS)=(185.736°,−114.291°). Resulting (X,Y)=(−3.384,4.2404).

FIG. 23—KPACS Demo demonstrating Function ‘TurnPriSec’ with (αP,αS)=(−104.376°,−44.657°). Resulting (X,Y)=(−5.528,−7.416).

FIG. 24—KPACS Demo demonstrating Function ‘TurnPriSec’ with (αP,αS)=(−39.876°,−13.413°). Resulting (X,Y)=(6.826,−7.214).

FIG. 25—KPACS Demo demonstrating Function ‘FindXY’ with (X,Y)=(8.157,1.6288). Resulting (αP,αS)=(45°,−67.417°).

FIG. 26—KPACS Demo demonstrating Function ‘FindXY’ with (X,Y)=(−3.384,4.2404). Resulting (αP,αS)=(185.736°,−114.291°).

FIG. 27—KPACS Demo demonstrating Function ‘FindXY’ with (X,Y)=(−5.528,−7.416). Resulting (αP,αS)=(−104.376°,−44.657°).

FIG. 28—KPACS Demo demonstrating Function ‘FindXY’ with (X,Y)=(6.826,−7.214). Resulting (αP,αS)=(−39.876°,−13.413°).

FIG. 29—KPACS Demo demonstrating Function ‘PlotFile’.

FIG. 30—Illustration of Physical Model of 2-Dimensional KPACPS realised from its Theoretical Model.

FIG. 31—Design and Construction of Typical Practical Model of the 2-Dimensional KPACPS realised from its Physical Model and Theoretical Model.

FIG. 32—Design and Construction of Typical Practical Model of the 2-Dimensional KPACPS realised from its Physical Model and Theoretical Model.

FIG. 33—Electrical Circuit of the Practical Model of the 2-Dimensional KPACPS.

FIG. 34—Flow Charts illustrating the Working of the 2-Dimentional KPACPS Machine.

FIG. 35—Picture of Numerically Controlled Pen Plotter. Working Prototype of the 2-Dimentional KPACPS.

FIG. 36—Picture of Numerically Controlled Pen Plotter. Working Prototype of the 2-Dimentional KPACPS.

FIG. 37—Design of Variant A of Typical Practical Model of 2-Dimensional KPACPS with Quad Secondary Motors and Quad Work Tools.

FIG. 38—Design of Variant A of Typical Practical Model of 2-Dimensional KPACPS with Quad Secondary Motors and Quad Work Tools.

FIG. 39—Design of Variant B of Typical Practical Model of 2-Dimensional KPACPS with Secondary Motor at the Centre of Primary Plate and Secondary Arm replaced by suitable Gear.

FIG. 40—Design of Variant B of Typical Practical Model of 2-Dimensional KPACPS with Secondary Motor at the Centre of Primary Plate and Secondary Arm replaced by suitable Gear.

FIG. 41—Design of Variant C of Typical Practical Model of 2-Dimensional KPACPS with Single Secondary Motor at the Centre of Primary Plate and Quad Work Tools connected by Gear Train.

FIG. 42—Design of Variant C of Typical Practical Model of 2-Dimensional KPACPS with Single Secondary Motor at the Centre of Primary Plate and Quad Work Tools connected by Gear Train.

FIG. 43—Illustration of Physical Model of 3-Dimensional KPACPS realised from its Theoretical Model.

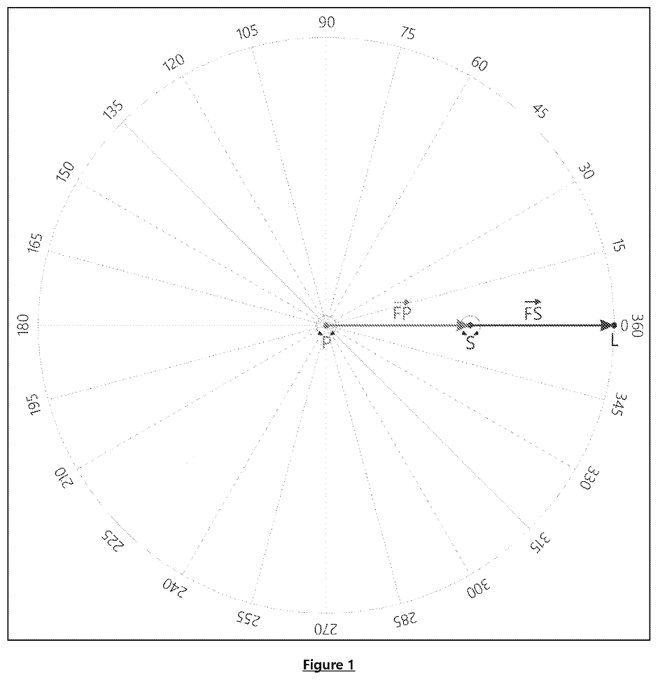

### SOFTWARE SIMULATION OF 2-DIMENSIONAL KPACS

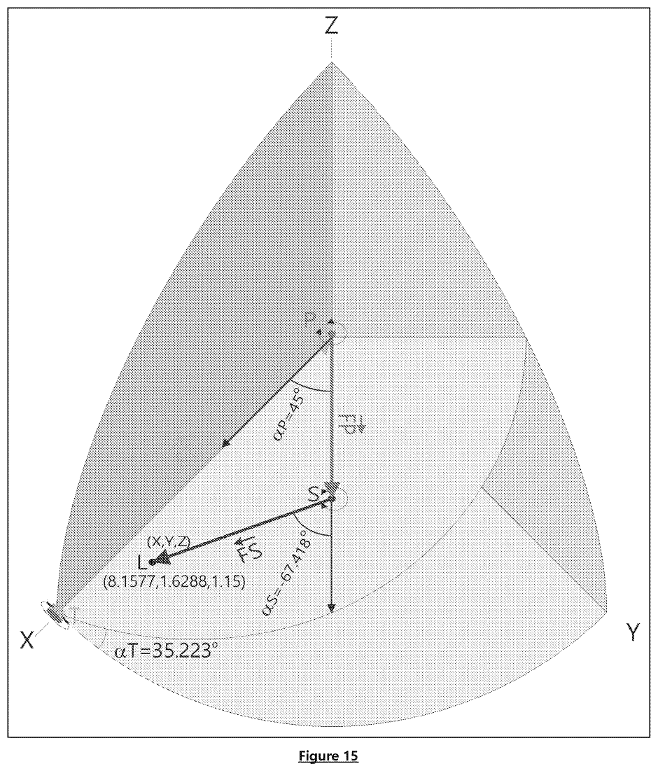

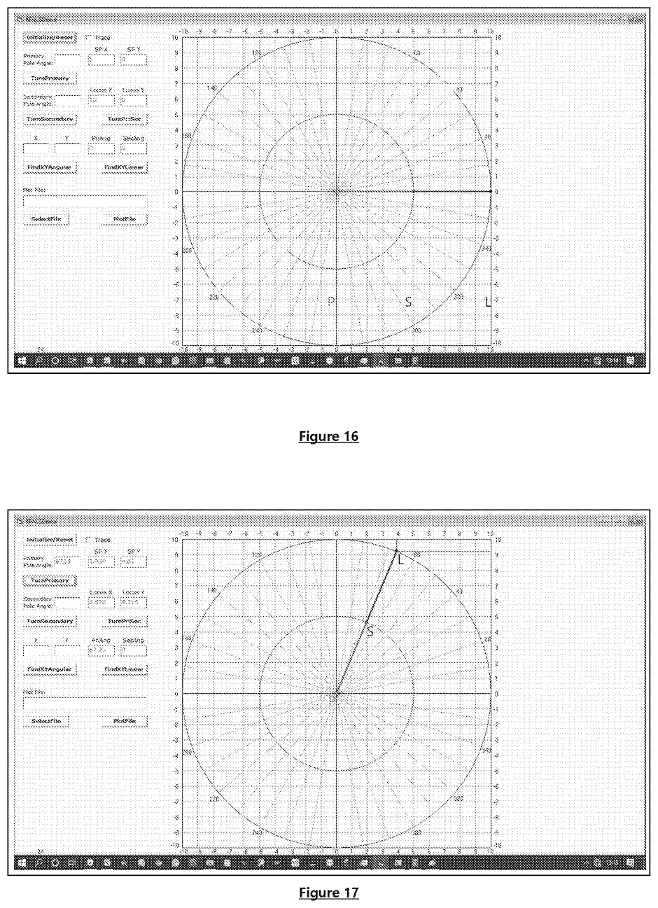

FIG. 16 to FIG. 29 show some Screen Shots from the Custom Built Software KPACS Demo for Demonstration of the 2-Dimensional KPACS illustrating different characteristics of KPACS as under.

FIG. 16 shows the Screen Shot of the Initial State of the 2-Dimentional KPACS in which both the Primary Kinetic Pole P and the Secondary Kinetic Pole S are at their respective Home Positions where αP=0° and αS=0°. The Software provides for Setting Various Parameters and Simulating the Function of the 2-Dimensional KPACS based on the set Parameter Values as under:
Setting αP and Simulating the Angular Position of the Primary Kinetic Pole P by means of Function ‘TurnPrimary’
Setting αS and Simulating the Angular Position of the Secondary Kinetic Pole S by means of Function ‘TurnSecondary’
Setting αP and αS and Simulating the Angular Positions of the Primary Kinetic Pole P and the Secondary Kinetic Pole S simultaneously by means of Function ‘TurnPriSec’
Setting the Cartesian Co-ordinates (x, y) and Simulating the Angular Positions of the Primary Kinetic Pole P and the Secondary Kinetic Pole S simultaneously such that Locus L is located at (x, y) by means of Function ‘FindXYAngular’

1Switching ON the Track to view the Path of the Locus L with every Simulation by Enabling Check Box ‘Track’.
Selecting a Line Drawing File by means of Function ‘SelectFile’ by and Plotting the same on the 2-Dimentional KPACS Plane by means of Function ‘PlotFile’
For every Action, the resulting X and Y Co-ordinates of the Secondary Pole (SP X and SP Y), X and Y Co-ordinates of the Locus (Locus X and Locus Y) and also the Primary Kinetic Pole Angle (PriAng), the Secondary Kinetic Pole Angle (SecAng) are Compiled and Displayed according to the functioning of the 2-Dimensional KPACS.

### TurnPrimary

FIG. 17 Demonstrates Function ‘TurnPrimary’:

αP (Primary Pole Angle in Figure) is set to 67.23°

Note that αS is unspecified and remains at its earlier value αS=0°

Since αS=0°, the Locus lies on the Periphery of the 2-Dimensional KPACS in the 1^{st} Quadrant

Note that Locus L (Locus X, Locus Y)=(3.876, 9.218) expressed in Cartesian Co-ordinates System is same as Locus L (αP,αS)=) (67.23°,0° expressed in 2-Dimensional KPACS

FIG. 18 Demonstrates Function ‘TurnPrimary’:

αP (Primary Pole Angle in Figure) is set to −114.89°, negative value, which shows that Rotation of Primary Kinetic Pole P is Bi-directional. Further, Rotation of Secondary Kinetic Pole S is also Bi-directional as will be seen in later Figures

Since αS=0°, the Locus lies on the Periphery of the 2-Dimensional KPACS in the 3^{rd} Quadrant

Note that Locus L (Locus X, Locus Y)=(−4.204,−9.074) expressed in Cartesian Co-ordinates System is same as Locus L (αP,αS)=(−114.890,0°) expressed in 2-Dimentional KPACS

### TurnSecondary

FIG. 19 Demonstrates Functions ‘TurnPrimary’ and ‘TurnSecondary’:

αP (Primary Pole Angle in FIG. 163.94° by function ‘TurnPrimary’

αS (Secondary Pole Angle in Figure) is set to −118.56° by function ‘TurnSecondary’

Note that αS is set to a negative value indicating that Rotation of Secondary Kinetic Pole S is also Bi-directional

Note that Locus L (Locus X, Locus Y)=(−1.294,4.94) located in the 2nd Quadrant and expressed in Cartesian Co-ordinates System is same as Locus L (αP,αS)=(163.94°,−118.56°) expressed in 2-Dimentional KPACS

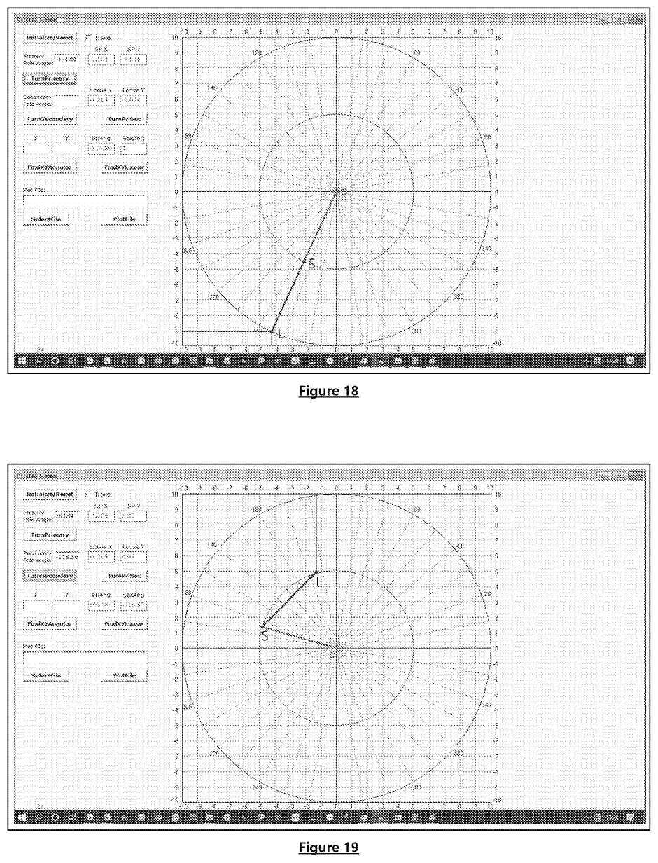

FIG. 20 Demonstrates Functions ‘TurnPrimary’ and ‘TurnSecondary’:

αP (Primary Pole Angle in Figure) −128.67° by function ‘TurnPrimary’

αS (Secondary Pole Angle in Figure) is set to −62.39° by function ‘TurnSecondary’

Note that both αP and αS are set to negative values

Note that the Locus L (Locus X, Locus Y)=(−2.454, 1.052) located in the 2nd Quadrant and expressed in Cartesian Co-ordinates System is same as Locus L (αP,αS)=(−128.67°,−62.39°) expressed in 2-Dimentional KPACS.

### TurnPriSec

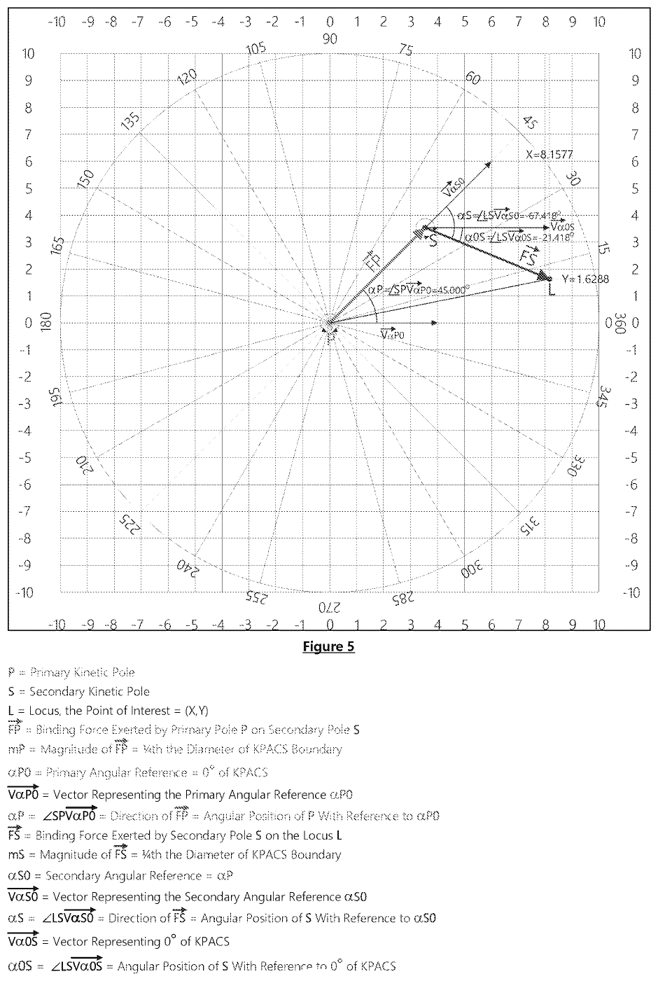

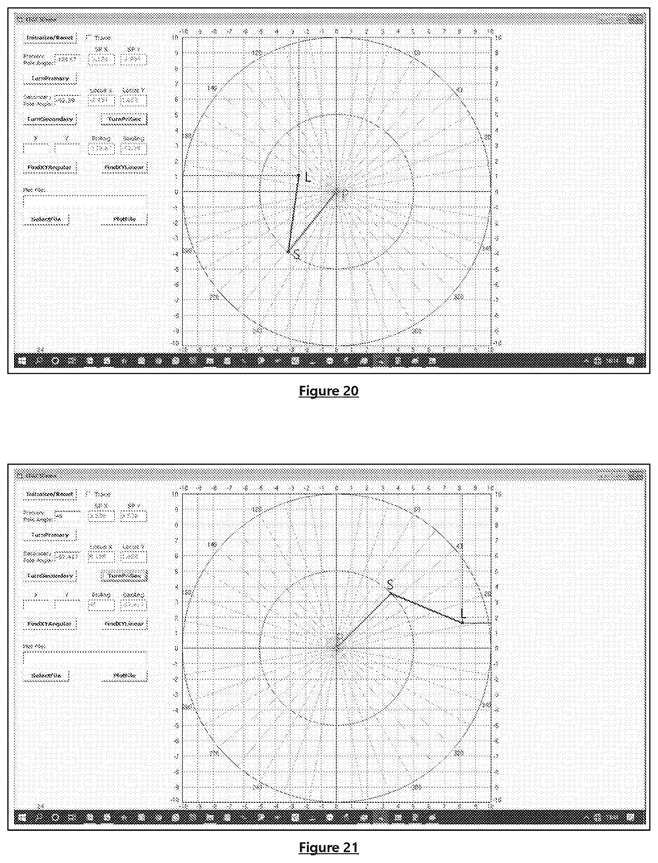

FIG. 21 Demonstrates the Corollary of earlier Example 1 of FIG. 5 by using Function ‘TurnPriSec’. The Cartesian Co-ordinates of Locus L as given in Example 1 are derived by setting the Angular Pair (αP,αS) to the values as computed from 2-Dimensional KPACS as in Example 1:

Angular Pair is set to (αP,αS)=(45°,−67.417°) as computed from 2-Dimensional KPACS in Example 1 by function ‘TurnPriSec’

Note that the resulting Locus L (Locus X, Locus Y)=(8.157, 1.6288) expressed in Cartesian Co-ordinates System is as given in Example 1

FIG. 22 Demonstrates the Corollary of earlier Example 2 of FIG. 6 by using Function ‘TurnPriSec’. The Cartesian Co-ordinates of Locus L as given in Example 1 are derived by setting the Angular Pair (αP,αS) to the values as computed from 2-Dimensional KPACS as in Example 2:

Angular Pair is set to (αP,αS)=(185.736°,−114.291°) as computed from 2-Dimensional KPACS in Example 2 by function ‘TurnPriSec’

Note that the resulting Locus L (Locus X, Locus Y)=(-3.384,4.2404) expressed in Cartesian Co-ordinates System is as given in Example 2

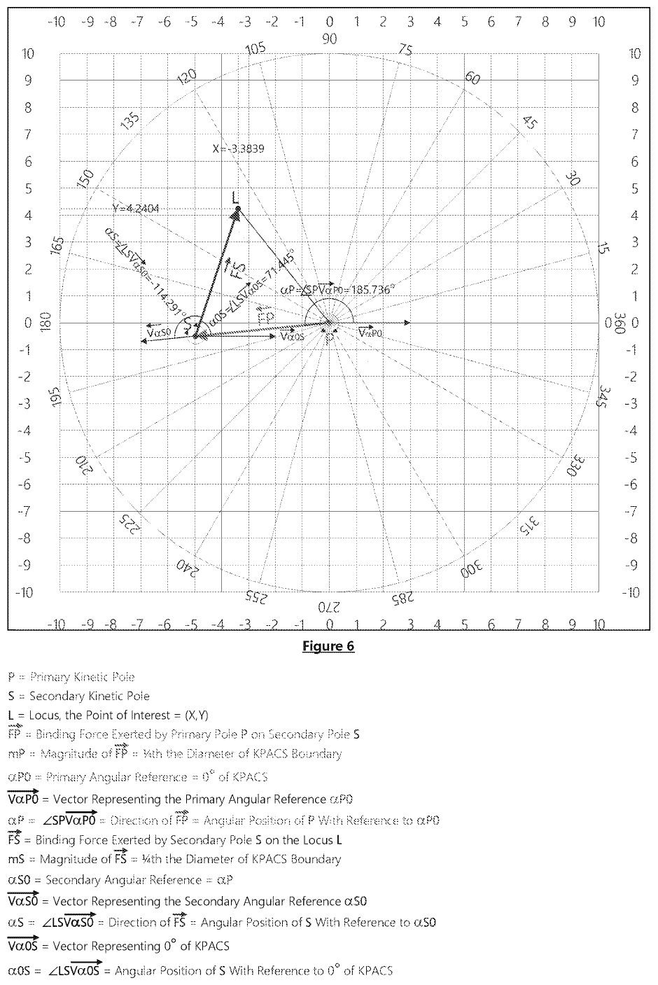

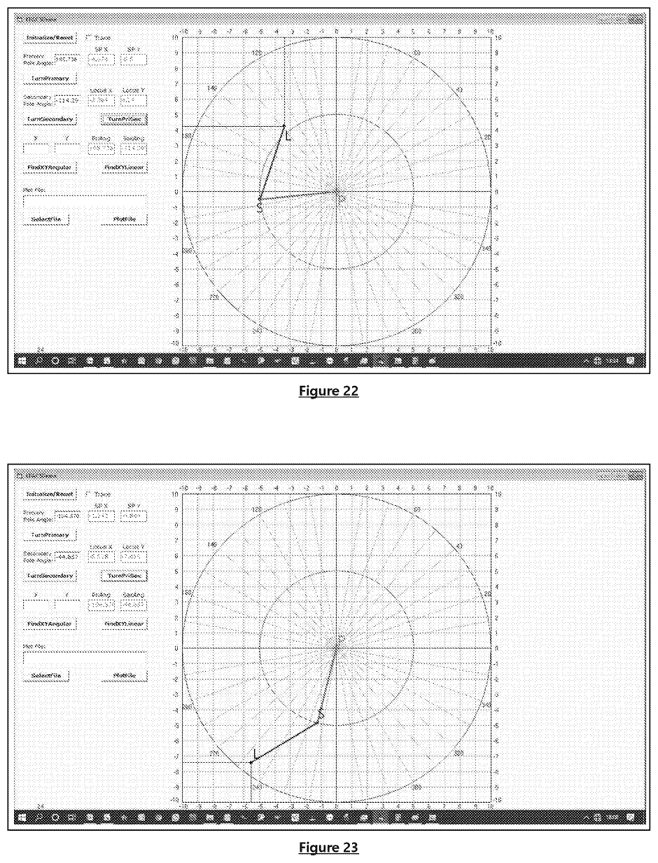

FIG. 23 Demonstrates the Corollary of earlier Example 3 of FIG. 7 while using Function ‘TurnPriSec’. The Cartesian Co-ordinates of Locus L as given in Example 1 are derived by setting the Angular Pair (αP,αS) to the values as computed from 2-Dimensional KPACS as in Example 3:

Angular Pair is set to (αP, αS)=(−104.376°,−44.657°) as computed from 2-Dimensional KPACS in Example 3 by function ‘TurnPriSec’

Note that the resulting Locus L (Locus X, Locus Y)=(−5.528,−7.416) expressed in Cartesian Co-ordinates System is as given in Example 3

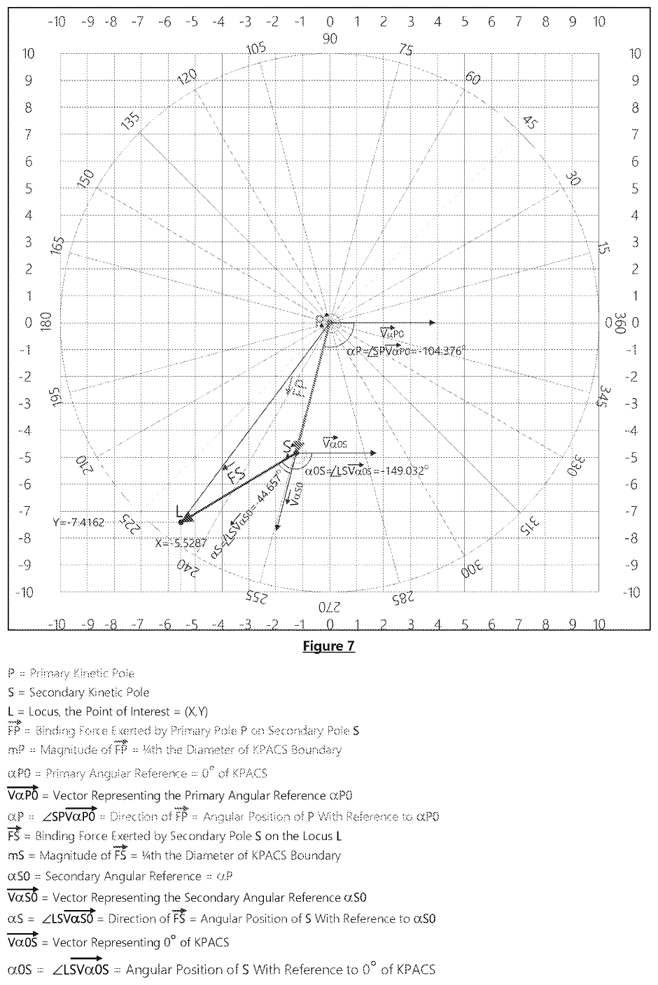

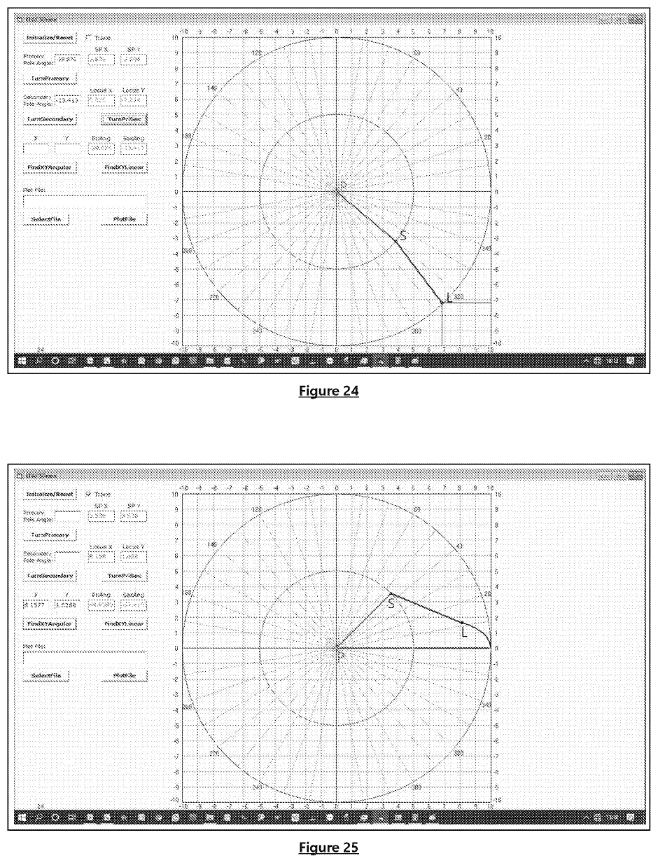

FIG. 24 Demonstrates the Corollary of earlier Example 4 of FIG. 8 while using Function ‘TurnPriSec’. The Cartesian Co-ordinates of Locus L as given in Example 1 are derived by setting the Angular Pair (αP,αS) to the values as computed from 2-Dimensional KPACS as in Example 4:

Angular Pair is set to (αP,αS)=(−39.876°,−13.413°) as computed from 2-Dimensional KPACS in Example 4 by function ‘TurnPriSec’

Note that the resulting Locus L (Locus X, Locus Y)=(6.826,−7.214) expressed in Cartesian Co-ordinates System is as given in Example 4.

### FindXY

FIG. 25 Demonstrates earlier Example 1 of FIG. 5 while using Function ‘FindXY’

Cartesian Co-ordinates (X,Y) are set to (8.157,1.6288) as given in Example 1 by function ‘FindXY’Angular Pair of Locus L (αP,xS)=(45°,−67.417°) is computed from 2-Dimensional KPACS as in Example 1

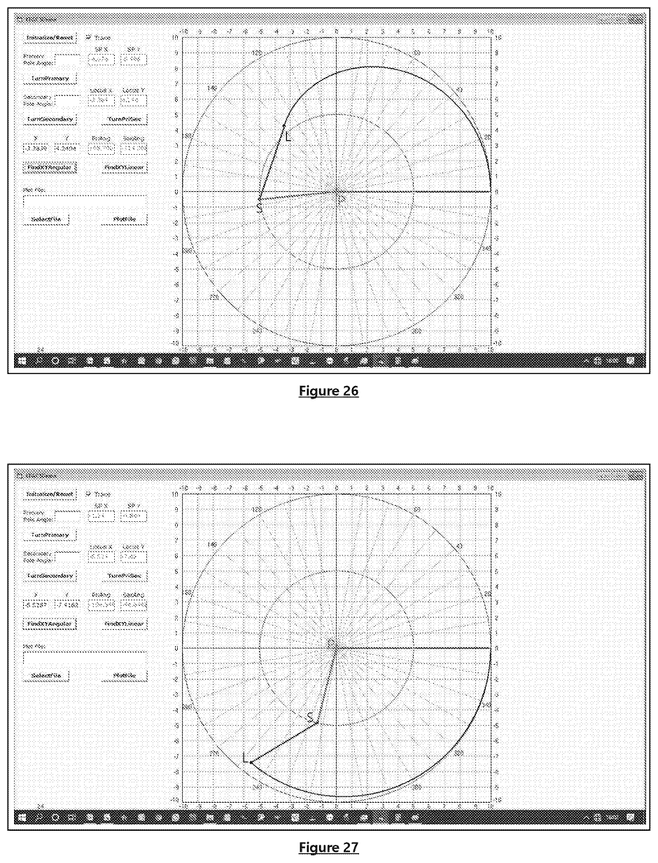

FIG. 26 Demonstrates our earlier Example 2 of FIG. 6 while using Function ‘FindXY’:

Cartesian Co-ordinates (X,Y) are set to (−3.384,4.2404) as given in Example 2 by function ‘FindXY’

Angular Pair of Locus L (αP,αS)=(185.736°,−114.291°) is computed from 2-Dimensional KPACS as in Example 2

FIG. 27 Demonstrates our earlier Example 3 of FIG. 7 while using Function ‘FindXY’:

Cartesian Co-ordinates (X,Y) are set to (−5.528,−7.416) as given in Example 3 by function ‘FindXY’

Angular Pair of Locus L (αP,αS)=(−104.376°,−44.657°) is computed from 2-Dimensional KPACS as in Example 3.

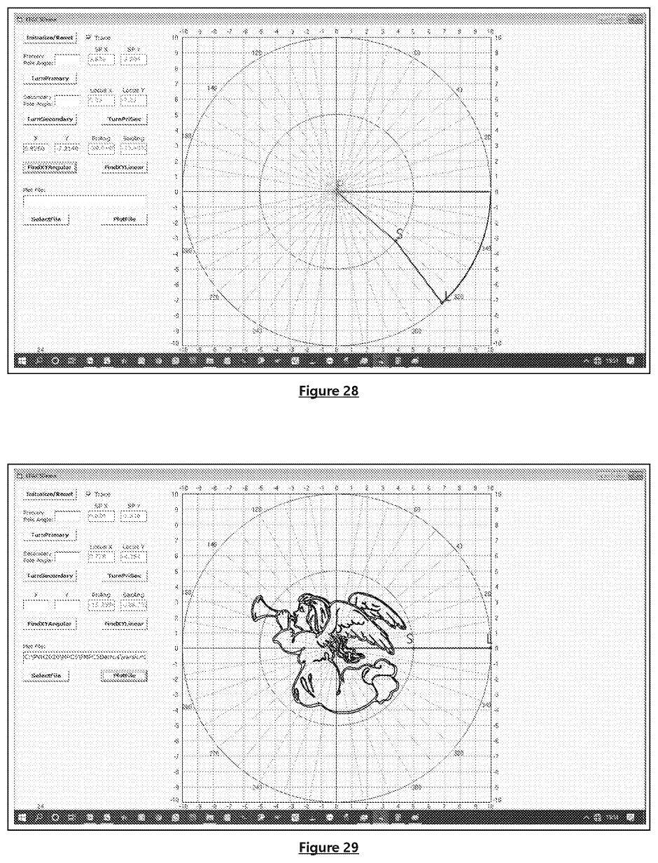

FIG. 28 Demonstrates our earlier Example 4 of FIG. 8 while using Function ‘FindXY’:

Cartesian Co-ordinates (X,Y) are set to (6.826,−7.214) as given in Example 3 by function ‘FindXY’.

Angular Pair of Locus L (αP,αS)=(−39.876°,−13.413°) is computed from 2-Dimensional KPACS as in Example 4.

### PlotFile

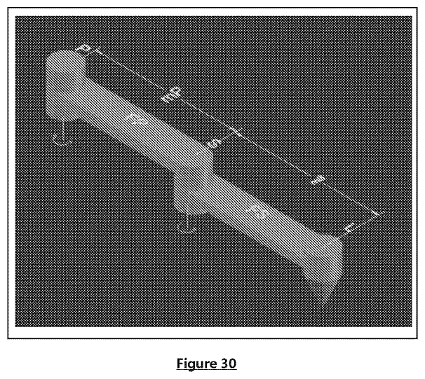

FIG. 29 Demonstrates the 2-Dimentional KPACS in which, a CAD Line Drawing File such as a plot File from an AutoCad Drawing is selected by function ‘SelectFile’. By using function ‘PlotFile’ the 2-Dimensional KPACS Angular Pair (αP, αS) is computed for every Pair of the Plot Data contained in the file in Cartesian Co-ordinates and the drawing is Plotted from the resulting set of Angular Pairs. This demonstrates the 2-Dimensional KPACS in its entirety.

Modelling Of 2-Dimensional KPACPS and 3-Dimensional KPACPS

Following is a description of the Realisation of Physical and Practical Models of 2-Dimensional and 3-Dimensional KPACPS from their Theoretical Models, the 2-Dimensional KPACS and 3-Dimensional KPACS:

Physical Model of 2-Dimensional KPACPS

FIG. 30 illustrates a Physical Model of the 2-Dimensional KPACPS which is realised from the Theoretical Model by replacing the Elements and Characteristics of KPACPS with Suitable Physical Elements and Characteristics in the Physical Model of KPACPS as detailed under:

The Primary Kinetic Pole P is modelled as a Shaft, called the Primary Kinetic Shaft P, which can be rotated in either direction about its Rotational Axis which is Perpendicular to the Plane of 2-Dimensional KPACPS. The Secondary Kinetic Pole S is modelled as a Shaft, called the Secondary Kinetic Shaft S, which can be rotated in either direction about its Rotational Axis which is Perpendicular to the Plane of 2-Dimensional KPACPS. The Locus L is modelled as Conical Shaft, called the Locater Shaft L whose Cylindrical Axis is Perpendicular to the Plane of 2-Dimensional KPACPS.

The Primary Kinetic Force FP is modelled as an Arm, called the Primary Arm FP, extending from and binding the Primary Kinetic Shaft P to the Secondary Kinetic Shaft S. The Magnitude of the Primary Kinetic Force, mP, is modelled as the Length of the Primary Kinetic Arm FP from the Centre of the Primary Kinetic Shaft P to the Centre of the Secondary Kinetic Shaft S.

The Secondary Kinetic Force FS is modelled as Arm, called the Secondary Arm FS, extending from and binding the Secondary Kinetic Shaft to the Locater L. The Magnitude of the Secondary Kinetic Force, mS, is modelled as the Length of the Secondary Arm FSfrom the Centre of the Secondary Kinetic Shaft Sto the Centre of the Locater L.

The various Components of the Physical Model of 2-Dimensional KPACPS are integrated as shown in the FIG. 30.

### Practical Model of 2-Dimensional KPACPS:

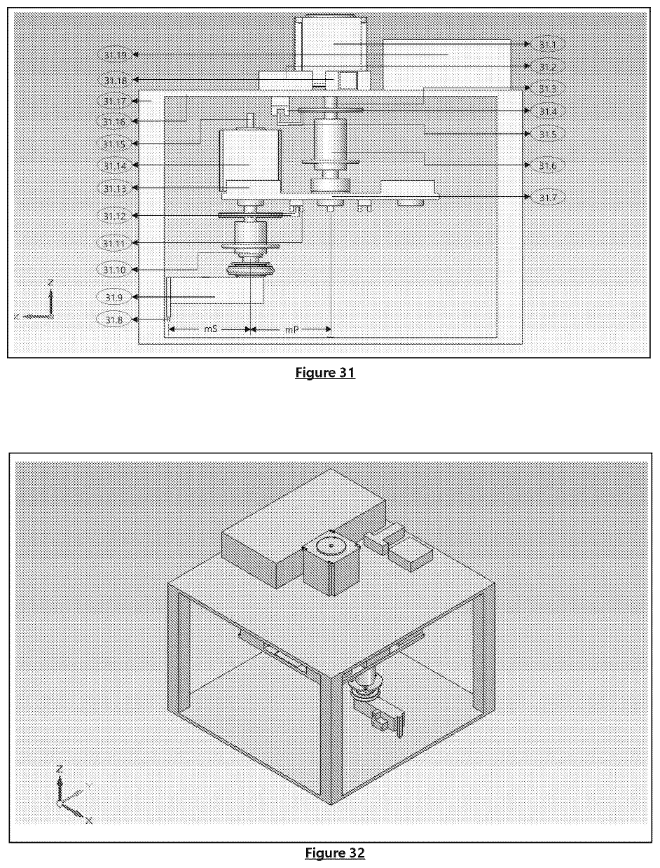

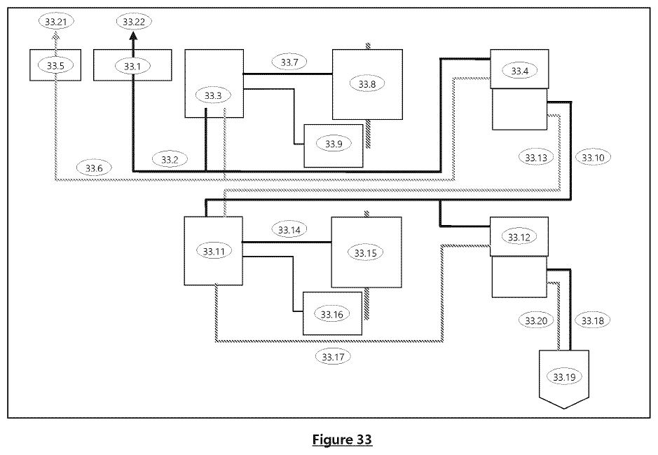

FIG. 31 and FIG. 32 illustrate the Design of a Typical Practical Model of the 2-Dimensional KPACPS realised from the Theoretical Model and Physical Model. The following is a description of Realisation, Construction, Working, Prototype Application and Variants of the Typical Practical Model of the 2-Dimensional KPACPS.

### Realisation Of Typical Practical Model Of 2-Dimensional KPACPS:

Similar to the realisation of the Physical Model of the 2-Dimensional KPACPS from the Theoretical Model, the Typical Practical Model of the 2-Dimensional KPACPS of FIG. 31 and FIG. 32 is realised by replacing the Elements and Characteristics of the Theoretical Model and the Physical Model by Suitable Practical Elements and Characteristics in the Typical Practical Model as detailed under:

Primary Kinetic Pole: The Primary Kinetic Pole P of the Theoretical Model and the Primary Kinetic Shaft P of the Physical Model is replaced by the Shaft of an Electric Motor such as a Stepper Motor, called the Primary Motor (31.1). The Characteristic Bi-directional Rotational Motion of the Primary Kinetic Pole P is derived by the Bi-directional Rotational Motion of the Primary Motor Shaft P (31.3) in the Typical Practical Model of the 2-Dimensional KPACPS.

Angular Position Of Primary Kinetic Pole: Controlling of the Primary Angular Position αP of the Primary Kinetic Pole P of the Theoretical Model and the Primary Kinetic Shaft P of the Physical Model is achieved by means of the Primary Motor Controller-Cum-Driver CP (31.2), which is an Integrated Programmable Electronic Device connected to the Primary Motor (31.1) for Controlling the Direction of Rotation, Angle of Rotation, Acceleration and Speed of Rotation of the Primary Motor Shaft P (31.3).

Primary Angular Reference: The Primary Angular Reference αP0 of the Theoretical Model is achieved by adapting a Suitable Optical Sensor called the Primary Home Sensor HP (31.4), an Electronic Device, along with a Suitable Pin attached to the Primary Motor Shaft P (31.3), which acts as the Primary Home Sensor Interrupter IP (31.5).

Primary Kinetic Force: The Primary Kinetic Force FP of the Theoretical Model and the Primary Arm FP of the Physical Model is replaced by a Suitable Plate, called the Primary Plate FP (31.7).

Secondary Kinetic Pole: The Secondary Kinetic Pole S of the Theoretical Model and the Physical Model is replaced by Shaft of an Electric Motor such as a Stepper Motor called the Secondary Motor (31.14). The Characteristic Bi-directional Rotational Motion of the Secondary Kinetic Pole S is derived by the Bi-directional Rotational Motion of the Secondary Motor Shaft S (31.15) in the Typical Practical Model of the 2-Dimensional KPACPS.

Angular Position Of Secondary Kinetic Pole: Controlling of the Secondary Angular Position αS of the Secondary Kinetic Pole S of the Theoretical Model and the Secondary Kinetic Shaft S (31.15) of the Physical Model is achieved by means of the Secondary Motor Controller-Cum-Driver CS (31.13), which is an Integrated Programmable Electronic Device connected to the Secondary Motor (31.14) and for Controlling the Direction of Rotation, Angle of Rotation, Acceleration and Speed of Rotation of the Secondary Motor Shaft S (31.15).

Secondary Angular Reference: The Secondary Angular Reference αS0 of the Theoretical Model and the Physical Model is achieved by adapting a Suitable Optical Sensor called the Secondary Home Sensor HS (31.11), an Electronic Device, along with a Suitable Pin attached to the Secondary Motor Shaft S (31.15), which acts as the Secondary Home Sensor Interrupter IS (31.12).

Secondary Kinetic Force: The Secondary Kinetic Force FS of the Theoretical Model and the Secondary Arm FS of the Physical Model is replaced by a Suitable Arm, called the Secondary Arm FS (31.9).

Locus: The Locus L of the Theoretical Model and the Locater Shaft L of the Physical Model is replaced by a Suitable Work Tool depending on the Application of the Practical Model, called the Work Tool L (31.8) Assembly. It is to be noted that the Axis of Rotation of the Primary Motor Shaft P (31.3), the Axis of Rotation of the Secondary Motor Shaft S (31.15) and the Axis of the Work Tool L (31.8) are parallel to each other.

Magnitude Of Primary Kinetic Force: The Magnitude of the Primary Kinetic Force FP, (=mP), of the Theoretical Model and the Length of the Primary Arm FP of the Physical Model is replaced by the Distance between the Axis of Rotation of the Primary Motor Shaft P (31.3) and the Axis of Rotation of the Secondary Motor Shaft S (31.15).

Magnitude Of Secondary Kinetic Force: The Magnitude of the Secondary Kinetic Force FS, (=mS), of the Theoretical Model and the Length of the Secondary Arm FS of the Physical Model is replaced by the Distance between the Axis of Rotation of the Secondary Motor Shaft S (31.15) and the Axis of Work Tool L (31.8).

Primary Slip Ring: The Primary Slip Ring RP (31.6) serves to Transfer Electrical Power and Signals to Secondary Motor Controller-Cum-Driver and Secondary Homing Sensor.

Secondary Slip Ring: The Secondary Slip Ring RS (31.10) serves to Transfer Electrical Power and Signals for the Work Tool Operation.

Work Tool Operation: The Work Tool (31.8) is operated by employing a Suitable Arrangement depending on the Application of the Practical Model.

Power Source: Source of DC Electrical Power required for Functioning of the Practical Model of the 2-Dimensional KPACS is derived from a Suitable Switch Mode Power Supply SMPS (31.19).

Communication Port: Communication Port (31.18) for Communication with the Host Computer Host Computer such as PC or Laptop or an Embedded Single Board Computer (SBC) or any Hand Held Computing Device with a Suitable Communication Channel such as Ethernet or WiFi).

Application Software: Customised Application Software Hosted on PC/Laptop for Controlling the Operation of the Machine via the Communication Port (31.18).

Top Plate: Suitable Top Plate (31.16) for mounting of Primary Motor (31.1), Primary Motor Controller-Cum-Driver (31.3), SMPS (31.19) and Communication Port (31.18) Port.

Machine Frame: Suitable Machine Frame (31.17).

Plane Of Interest: The Circular Plane-Of-Interest, which defines the Work Area of the Practical Model, is situated such that the Tip of the Work Tool lies on it when activated and is Perpendicular to the Axis of Rotation of the Primary Motor Shaft P, the Axis of Rotation of the Secondary Motor Shaft S and the Axis of the Work Tool, all three Axes being Parallel to each other, and its Centre is on the Axis of Rotation of the Primary Motor Shaft P. The Circular Boundary of the Plane-Of-Interest is defined by the Circle of Radius=mP+mS with its Centre at the Centre of the Plane-Of-Interest.

Table which consolidates Realisation of the Typical Practical Model of the 2-Dimensional KPACPS from its Theoretical Model and the Physical Model can be found in Appendix-C.

Construction of Typical Practical Model of 2-Dimensional KPACPS

Construction of the Typical Practical Model of the 2-Dimensional KPACS of FIG. 31 and FIG. 32 from the Realisation of its Elements and Characteristics from the Theoretical Model and the Physical Model is as detailed under:

Machine Frame And Top Plate: The Top Plate (31.16) is fastened to the top of the Machine Frame (31.17).

SMPS: The SMPS (31.19) is suitably mounted on the Top Plate (31.16).

Communication Port: The Communication Port (31.18) Communication Device, which is used for Communication with the Host Computer for Operation of the Machine, is suitably mounted on the Top Plate (31.16).

Primary Motor: The Primary Motor (31.1) is mounted at the Centre of the Top Plate (31.16) such that the Primary Motor Shaft P (31.3) extends perpendicularly through a suitable hole at the Centre of the Top Plate (31.16).

Primary Motor Controller: The Primary Motor Controller-Cum-Driver CP (31.2) is suitably mounted on the Top Plate (31.16).

Primary Homing Sensor: The Primary Homing Sensor HP (31.4) is suitably mounted on the Bottom Side of the Top Plate (31.16) near the Primary Motor Shaft P (31.3) on a Suitable Bracket and aligned to 0° of the 2-Dimensional KPACS Plane.

Primary Homing Sensor Interrupter: The Primary Homing Sensor Interrupter IP (31.5) is suitably mounted on the Primary Motor Shaft P (31.3) on a Suitable Circular Disc in such a manner that, as the Primary Motor Shaft P (31.3) rotates, whenever the Primary Homing Sensor Interrupter IP (31.5) is aligned to 0° of the 2-Dimensional KPACS Plane, it Interrupts the Primary Homing Sensor HP (31.4), which results in a change of state in the Primary Homing Sensor Signal thereby asserting that the Angular Position of the Primary Motor Shaft P (31.3) is at the Primary Angular Reference=0° of the 2-Dimensional KPACS Plane.

Primary Slip Ring: The Stator of the Primary Slip Ring RP (31.6) is fastened to a Suitable Bracket mounted on the Bottom Side of the Top Plate (31.16) and its Rotor fixed on to the Primary Motor Shaft P (31.3) below the Primary Homing Sensor Interrupter IP (31.5) such that, the Rotor of the Primary Slip Ring RP (31.6) rotates along with the Primary Motor Shaft P (31.3).

Primary Plate: The Primary Plate FP (31.7) is suitably mounted perpendicularly to the Primary Motor Shaft P (31.3) below the Primary Slip Ring RP (31.6) such that, the Primary Plate FP (31.7) rotates along with the Primary Motor Shaft P (31.3).

Secondary Motor: The Secondary Motor (31.14) is mounted on the Primary Plate FP (31.7) such that the Secondary Motor Shaft S (31.15) extends Perpendicularly through a Suitable Hole in the Primary Plate FP (31.7) in such a manner that the distance between the Axis of Rotation of the Primary Motor Shaft P (31.3) and the Axis of Rotation of the Secondary Motor Shaft S (31.15) equals 1/4^{th} the Diameter of the Circular Boundary of the 2-Dimensional KPACS.

Secondary Motor Controller: The Secondary Motor Controller-Cum-Driver CS (31.13) is suitably mounted on the Primary Plate FP (31.7).

Secondary Homing Sensor: The Secondary Homing Sensor HS (31.11) is suitably mounted on the Bottom Side of the Primary Plate FP (31.7) near the Secondary Motor Shaft S (31.15) on a Suitable Bracket and aligned to 0° of the 2-Dimensional KPACS Plane when the Primary Motor Shaft P (31.3) is at the Primary Angular Reference αP0 equal to 0° of the 2-Dimensional KPACS Plane.

Secondary Homing Sensor Interrupter: The Secondary Homing Sensor Interrupter IS (31.12) is suitably mounted on the Secondary Motor Shaft S (31.15) on a Suitable Circular Disc in such a manner that, as the Secondary Motor Shaft S (31.15) rotates, whenever the Secondary Homing Sensor Interrupter IS (31.12) is aligned to Primary Angular Position αP, it Interrupts the Secondary Homing Sensor HS (31.11), which results in a change of state in the Secondary Homing Sensor Signal thereby asserting that the Angular Position of the Secondary Motor S (31.15) is equal to 0°.

Secondary Slip Ring: The Stator of the Secondary Slip Ring RS (31.10) is fastened to a Suitable Bracket mounted on the Bottom Side of the Primary Plate FP (31.7) and its Rotor fixed on to the Secondary Motor Shaft S (31.15) below the Secondary Homing Sensor Interrupter IS (31.12) such that, the Rotor of the Secondary Slip Ring RS (31.10) rotates along with the Secondary Motor Shaft S (31.15).

Secondary Arm: The Secondary Arm FS (31.9) is suitably mounted perpendicularly to the Secondary Motor Shaft S (31.8) below the Secondary Slip Ring RS (31.10) such that, the Secondary Arm FS (31.9) rotates along with the Secondary Motor Shaft S (31.15). The Length of the Secondary Arm FS (31.9) is derived in such a manner that the distance between the Axis of Rotation of the Secondary Motor Shaft S (31.15) and the Tip of the Work Tool L (31.8) when assembled (equal to mS) equals the distance between the Axis of Rotation of the Primary Motor Shaft P (31.3) and the Axis of Rotation of the Secondary Motor Shaft S (31.15).

Work Tool Assembly: The Work Tool Assembly is suitably mounted on the Secondary Arm FS (31.9) such that the Work Tool L (31.8) is Perpendicular to 0° of the 2-Dimensional KPACS Plane and the distance (equal to mS) between the Axis of Rotation of the Secondary Motor Shaft S (31.15) and the Tip of the Work Tool L (31.8) when assembled equals the distance (equal to mP) between the Axis of Rotation of the Secondary Motor Shaft S (31.15) and the Axis of Rotation of the Primary Motor Shaft P (31.3).

Work Tool Controller: Operation of the Work Tool L (31.8) is controlled by means of a suitable Work Tool Controller mounted on the Secondary Arm FS (31.9).

Application Software: The Customised Application Software, which is an Extended Version of the Simulation Software of FIG. 16 to FIG. 29 discussed earlier, for the Operation of the Practical Model, Installed on the Host Computer connected to the Machine via the Communication Port. It Controls the Operation of the Machine based on Input Data such as a CAD File to complete the Application to Produce the Desired Output from the Practical Model of the 2-Dimensional KPACS.

Electrical Circuit: FIG. 33 illustrates the Electrical Circuit of the Practical Model of the 2-Dimensional KPACPS as described under:

AC Input Terminals of SMPS (33.1) are connected to AC Mains Power. The DC Power (33.2) Output Terminals are connected to the DC Power Input Terminals of the Primary Motor Controller-Cum-Driver (CP) (33.3) and Designated Stator Terminals of the Primary Slip Ring (RP) (33.4).

Input Port of Communication Port (33.5) is connected to the Host Computer. The Communication Bus (33.6), derived from the Communication Port (33.5) is Connected to Communication Terminals of the Primary Motor Controller-Cum-Driver (CP) (33.3) and Designated Stator Terminals of the Primary Slip Ring (RP) (33.4).

Primary Motor Drive (33.7) Output Terminals of the Primary Motor Controller-Cum-Driver (CP) (33.3) are connected to the Designated Terminals of Primary Motor (33.8).

Primary Home Sensor (HP) (33.9) Terminals are connected to the Home Sensor (33.7) Terminals of the Primary Motor Controller-Cum-Driver (CP) (33.3).

Extended DC Power (33.10) Terminals of Rotor of Primary Slip Ring (RP) (33.4) are connected to DC Power Input Terminals of the Secondary Motor Controller-Cum-Driver (CS) (33.11) and Designated Stator Terminals of the Secondary Slip Ring (RS) (33.12).

Extended Communication Bus (33.13) Terminals of Rotor of Primary Slip Ring (RP) (33.4) are connected to the Communication Bus Terminals of Secondary Motor Controller-Cum-Driver (CS) (33.11).

Secondary Motor Drive (33.14) Output Terminals of the Secondary Motor Controller-Cum-Driver (CS) (33.11) are connected to the Designated Terminals of Secondary Motor (33.15).

Secondary Homing Sensor (HS) (33.16) Terminals are connected to the Homing Sensor Terminals of Secondary Motor Controller-Cum-Driver (CS) (33.11).

Work Tool Assembly Control Signal (33.17) of Secondary Motor Controller-Cum-Driver (CS) (33.11) are Connected to Designated Stator Terminals of the Secondary Slip Ring (RS) (33.12).

Extended Work Tool DC Power (33.18) Terminals of Rotor of Secondary Slip Ring (RS) (33.12) are connected to DC Power Input Terminals of the Work Tool Assembly (L) (33.19).

Extended Work Tool Assembly Control Signal (33.20) of Rotor of Secondary Slip Ring (RS) are Connected to Control Input Terminals of the Work Tool Assembly (L) (33.19). Working Of Typical Practical Model of 2-Dimensional KPACPS

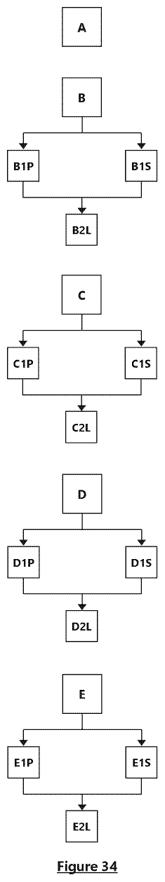

Function wise Work Flow of the Practical Model of the 2-Dimensional KPACPS is illustrated in Flow Charts of FIG. 34. As seen, each Usage Function of the Application Software results in Completion of the Intended Work of the Application of the Practical Model of the 2-Dimensional KPACPS.

Pre-conditions: Pre-conditions (A) for working are as under:

The KPACPS Machine is Powered Up and Ready.

The Host Computer is connected to the KPACPS Machine via the Communication Port and Running the KPACPS Application Software.

Initialisation: The Initialisation Function (B) of the KPACPS Application Software sends a Homing Command to the KPACPS Machine which results in the following actions:

The Primary Section (B1P) and the Secondary Section (B1S) act synchronously as under:

The Primary Motor Controller-Cum-Driver Drives the Primary Motor, which results in the Primary Motor Shaft to Rotate until the Primary Homing Sensor is interrupted by the Primary Homing Sensor Interrupter and the Primary Angular Position is set to Primary Angular Reference=0° of the 2-Dimensional KPACPS Plane.

The Secondary Motor Controller-Cum-Driver Drives the Secondary Motor, which results in the Secondary Motor Shaft to Rotate until the Secondary Homing Sensor is interrupted by the Secondary Homing Sensor Interrupter and the Secondary Angular

Position is set to Secondary Angular Reference=Primary Angular Position=Primary Angular Reference=0° of the 2-Dimensional KPACPS Plane.

The Work Tool Section (B2L) acts as under:

Location of Work Tool Continuously Changes while either Primary Motor Shaft or Secondary Motor Shaft is Rotating to Attain Primary Angular Reference or Secondary Angular Reference Respectively and the Work Tool Attains its Home Location at 0° on the Periphery of the 2-Dimensional KPACPS Circular Plane when the Primary Motor Shaft and the Secondary Motor Shaft attain their respective Homing Positions.

Test Run: The Test Run Function (C) of the KPACPS Application Software sends a Sequence of Commands to test the Working of the KPACPS Machine by Setting Various Values for the Primary Angular Position and the Secondary Angular Position resulting in the following actions:

The Primary (C1P) and the Secondary (C1S) Sections act synchronously as under:

The Primary Motor Controller-Cum-Driver Drives the Primary Motor to Set Various Primary Angular Positions derived from the Sequence of Commands, which results in the Primary Motor Shaft to Rotate to Set Primary Angular Positions in Sequence and Return to the Primary Homing Position=Primary Angular Reference=0° of the 2-Dimensional KPACPS Plane.

The Secondary Motor Controller-Cum-Driver Drives the Secondary Motor to Set Various Secondary Angular Positions derived from the Sequence of Commands, which results in the Secondary Motor Shaft to Rotate to Set Secondary Angular Positions in Sequence and Return to the Secondary Homing Position=Secondary Angular Reference=Primary Angular Reference=0° of the 2-Dimensional KPACPS Plane.

The Work Tool Section (C2L) acts as under:

Location of Work Tool Continuously Changes while either Primary Motor Shaft or Secondary Motor Shaft is Rotating to Attain Various Primary Angular Positions or Secondary Angular Positions Respectively and the Work Tool Attains its Final Set Position Resulting from the Set Primary and Secondary Angular Pair (αP, αS) when the Primary Motor Shaft and the Secondary Motor Shaft Attain their each of their Various Set Angular Positions Respectively. Find XY: The Find XY Function (D) of the KPACPS Application Software Compiles 2-Dimensioal KPACPS Primary and Secondary Angular Pair (αP,αS) for Specified Cartesian Co-ordinates Pair (X,Y) and Sends Sequence of Commands to Turn the Primary Motor Shaft and Secondary Motor Shaft to their Compiled Angular Positions αP and αS Respectively resulting in the following actions:

The Primary (D1P) and the Secondary (D1S) Sections act synchronously as under:

The Primary Motor Controller-Cum-Driver Drives the Primary Motor to Set the Primary Angular Position to the Compiled Value of αP, which results in the Primary Motor Shaft to Rotate to the Primary Angular Position αP.

The Secondary Motor Controller-Cum-Driver Drives the Secondary Motor to Set the Secondary Angular Position to the Compiled Value of αS, which results in the Secondary Motor Shaft to Rotate to the Secondary Angular Position αS.

The Work Tool Section (D2L) acts as under:

Location of Work Tool Continuously Changes while either Primary Motor Shaft or Secondary Motor Shaft is Rotating to Attain Various Primary Angular Positions or Secondary Angular Positions Respectively and the Work Tool Attains its Final Set Position Resulting from the Set Primary and Secondary Angular Pair when the Primary Motor Shaft and the Secondary Motor Shaft Attain their Set Angular Positions Respectively corresponding to the Specified Cartesian Co-ordinates Pair (X, Y).

Plot File: The Plot File Function (E) Compiles 2-Dimensioal KPACPS Primary and Secondary Angular Pairs (αP, αS) for Every Cartesian Co-ordinates Pair (X,Y) in the Selected CAD Plot File and Sends Sequence of Commands to Turn the Primary Motor Shaft and Secondary Motor Shaft to their Compiled Angular Positions (αP,αS) and the Work Tool Status for Every Angular Pair (αP,αS) resulting in the following actions:

For Each Pair of the Primary Angular Position and the Secondary Angular Position (αP, αS), the Primary (E1P) and the Secondary (E1S) Sections act Synchronously as under:

The Primary Motor Controller-Cum-Driver Drives the Primary Motor to Set the Primary Angular Position to the Compiled Value of αP, which results in the Primary Motor Shaft to Rotate to the Primary Angular Position αP.

The Secondary Motor Controller-Cum-Driver Drives the Secondary Motor to Set the Secondary Angular Position to the Compiled Value of as, which results in the Secondary Motor Shaft to Rotate to the Secondary Angular Position αS.

For Each Pair of the Primary Angular Position and the Secondary Angular Position (αP, αS), the Work Tool Section (E2L) acts as under:

Location of Work Tool Continuously Changes while either Primary Motor Shaft or Secondary Motor Shaft is Rotating to Attain the Set Primary Angular Position or Secondary Angular Positions Respectively and the Work Tool Attains its Final Set Position Resulting from the Set Primary and Secondary Angular Pair when the Primary Motor Shaft and the Secondary Motor Shaft Attain their Set Angular Positions Respectively and the Work Tool Status Changes to the Set Status corresponding to the Set Cartesian Co-ordinates Pair (X,Y).

Angular Resolution And Accuracy Of 2-Dimensional KPACS

While there is no limit to the Angular Resolution of the Theoretical Model of the 2-Dimensional KPACS, the Achievable Angular Resolution of the Practical Model of the 2-Dimensional KPACS is defined by the Minimum Permissible Angular Rotation of the Primary and Secondary Motor, which depends on the Type, Specification and Performance Quality of the Selected Primary and Secondary Motors.

For example, a Stepper Motor of Step Resolution 1.8° Per Step when Driven by a Micro-Stepping Stepper Motor Controller-Cum-Driver Working at 256 Micro Steps Per Step Yields an Angular Resolution of 0.00703125°, whereas a Stepper Motor of Step Resolution 0.9° Per Step Yields an Angular Resolution of 0.003515625°, under the same conditions.

Angular Accuracy is defined as the Precision of Primary and Secondary Angular Positioning. Again, while there is no limit to the Angular Accuracy of the Theoretical Model of the 2-Dimensional KPACS, the Achievable Angular Accuracy of the Practical Model of the 2-Dimensional KPACS is again dependent on the Type, Specification and Performance Quality of the Selected Primary and Secondary Motors. Better Angular Positioning can be achieved by more Precisely Controlling the Primary and Secondary Angular Positioning by Employing Angular Position Feedback from Angular Position Encoders on the Primary and Secondary Motors. Further, Higher Resolution Position Encoder Yields Better Positional Accuracy.

Prototype Of Typical Practical Model Of 2-Dimensional KPACPS

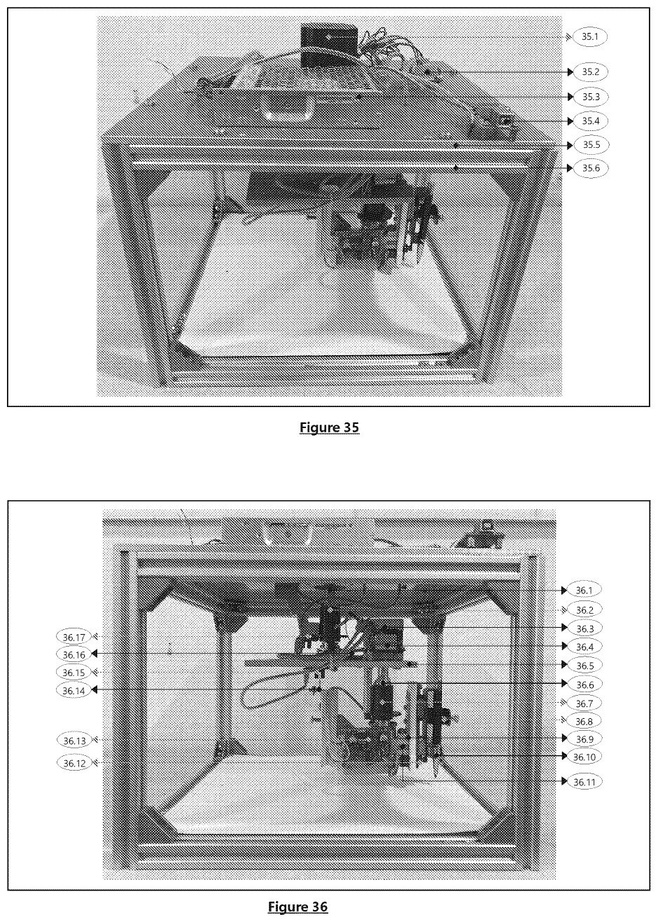

FIG. 35 and FIG. 36 show Pictures of a Numerically Controlled Pen Plotter which is the First Working Prototype of the 2-Dimentional KPACPS described as under:

The Pen Plotter Comprises of the following Components:
Primary Motor (35.1)
Primary Motor Controller-Cum-Driver (35.2)
SMPS (35.3)
USB Port (35.4)
Top Plate (35.5)
Machine Frame (35.6)
Primary Motor Shaft (36.1)
Primary Slip Ring (36.2)
Primary Plate (36.5)
Primary Homing Sensor (36.17)
Primary Homing Sensor Interrupter (36.16)
Secondary Motor (36.3)
Secondary Motor Controller-Cum-Driver (36.4)
Secondary Motor Shaft (36.6)
Secondary Slip Ring (36.7)
Secondary Homing Sensor (36.15)
Secondary Homing Sensor Interrupter (36.14)
Secondary Arm (36.11)
Plotter Pen Holder Assembly (36.9)
Plotter Pen Holder (36.8)
Plotter Pen Controller (36.13)
Micro Servo Motor for Plotter Pen Drive (36.12)
Plotter Pen (36.10)

The Work Tool of the Pen Plotter is the Plotter Pen which is held by the Plotter Pen Assembly mounted on the Secondary Arm.

The Plotter Pen Assembly comprises of a Pen Holder which can slide along a tiny Guide-Way mounted on the Base Plate of the Assembly.

Mounted on the Base Plate is also a Micro Servo Motor with a tiny Arm fixed to its Shaft. Whenever the Servo Motor Shaft turns, its Arm pushes the Plotter Pen Holder along with the Plotter Pen such that it slides along the Guide-Way one way or the other. The Servo Motor is driven by an Associated Electronic Driver.

Thus the Up or Down Action of the Plotter Pen while Plotting is achieved by Driving the Servo Motor accordingly, which is Controlled by the Work Tool Control Signal from the Secondary Motor Controller-Cum-Driver.

The Pen Plotter is connected to the Host PC running the Application Software via the USB Port.

The ‘PlotFile’ Function of the Application Software reads the Selected Plot file of a CAD Drawing and Compiles the Angular Pair (αP,αS) for each Cartesian Co-ordinate Pair (X,Y) contained in the Plot File and sends Appropriate Commands along with Pen Status (Up/Down) to the Pen Plotter, which Plots the CAD Drawing.

Variants Of Typical Practical Model Of 2-Dimensional KPACS

Several Variants of the Typical Practical Model of 2-Dimensioanl KPACS are presented as under. These Variants are realised by the same Theoretical Model of 2-Dimensional KPACS as the Typical Practical Model of FIG. 31 and FIG. 32, but differ in Construction to Yield Several Advantages such as Better Performance, Higher Efficiency and Better Economy.

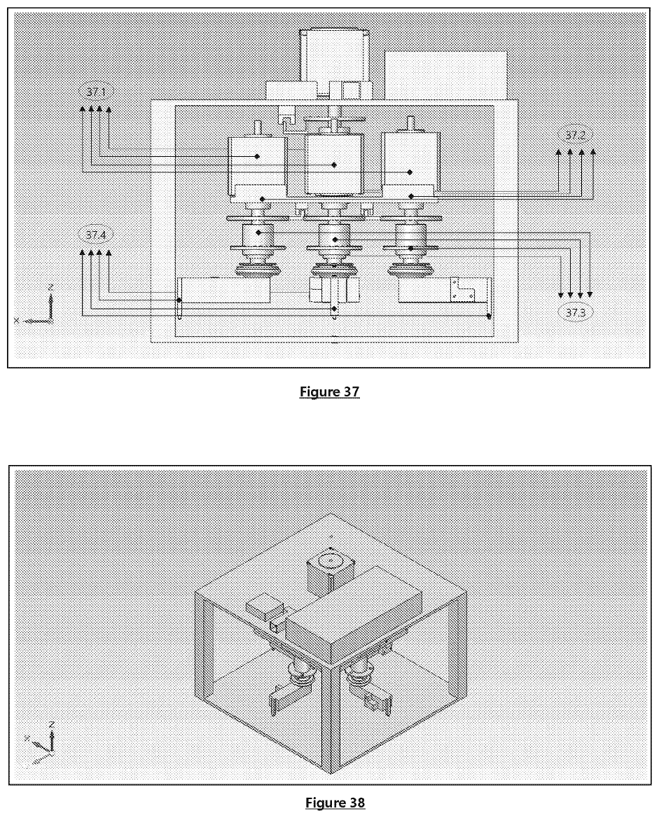

Variant A: FIG. 37 and FIG. 38 illustrate Variant A of the Typical Practical Model of the 2-Dimensional KPACPS of FIG. 31 and FIG. 32. It Comprises of Quad Secondary Motors (37.1) Mounted 90° Apart on the Primary Plate along with other Components associated with the Quad Secondary Motors including Associated Quad Secondary Motor Controller-Cum-Drivers (37.2), Associated Quad Secondary Slip Rings (37.3), Associated Quad Work Tool (4) Assemblies, Associated Secondary Homing Sensors, Associated Secondary Arms, and other Necessary Components for Operation of the System.

The Variant A with Quad Secondary Motors (1) and Quad Work Tool (37.4) Assemblies, each one Designated to a Predetermined Quadrant, allows for Simultaneous Working on 4 Jobs, each one Located in its Designated Quadrant. This will increase Productivity by 4 Times as compared to a Single Secondary Motor covering all the 4 Quadrants.

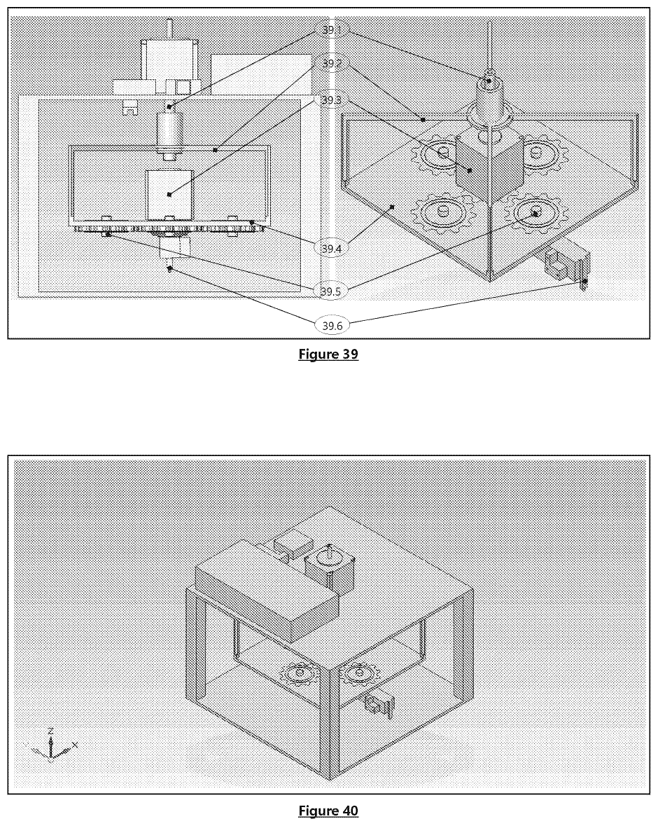

Variant B: Figure 39 and FIG. 40 illustrate Variant B of the Typical Practical Model of FIG. 31 and FIG. 32, in which the Primary Plate is driven by the Primary Motor Shaft (39.1) by means of 4 Primary Motor Spokes (39.2), fastened to the 4 Corners of the Primary Plate.

The Secondary Motor (39.3) is mounted in the Centre of the Primary Plate (39.4) along with Secondary Gear Train (39.5) comprising of a Drive Gear mounted on the Secondary Motor Shaft and 4 Driven Gears along with their Shafts. Each Driven Gear has 1:1 Ratio with the Drive Gear, such that the Distance between the Centres of the Drive and the Driven Gears is equal to the Designed Magnitude of the Secondary Kinetic Force. Fastened to one of the Driven Gear Shafts is the Secondary Arm on which is mounted the Work Tool (39.6) Assembly.

The Variant B results in Better Balance as the Secondary Motor is mounted in the Centre of the Primary Plate unlike the Typical Practical Model of FIG. 31 and FIG. 32, thereby yielding Better Performance.

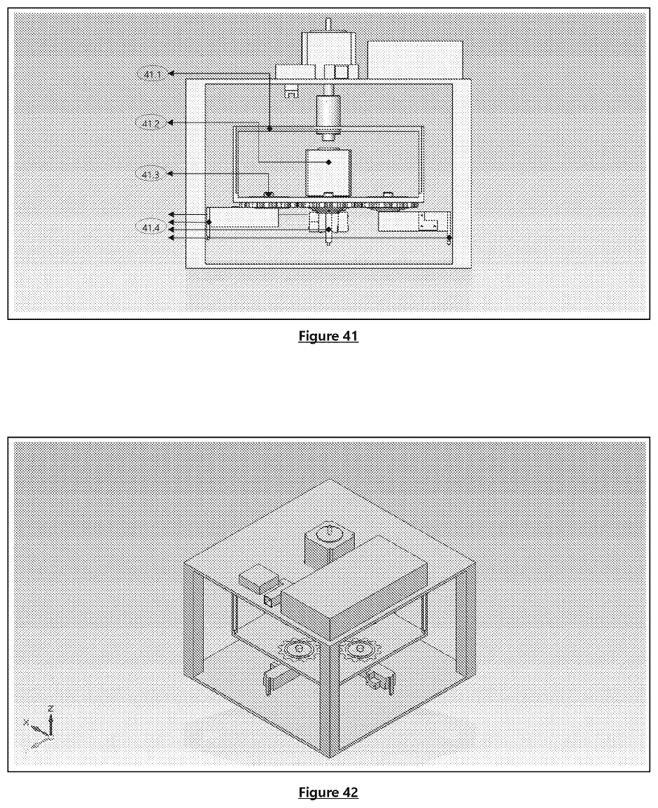

Variant C: FIG. 41 and FIG. 42 illustrate Variant C of the Typical Practical Model of FIG. 31 and FIG. 32, in which the Primary Plate is driven by the Primary Motor Shaft by means of 4 Primary Motor Spokes (41.1), fastened to the 4 Corners of the Primary Plate.

The Secondary Motor (41.2) is mounted in the Centre of the Primary Plate along with the Gear Train (41.3) comprising of a Drive Gear mounted on the Secondary Motor Shaft and 4 Driven Gears along with their Shafts. Each Driven Gear has 1:1 Ratio with the Drive Gear, such that the Distance between the Centres of the Drive and the Driven Gears is equal to the Designed Magnitude of the Secondary Kinetic Force. Fastened to the Driven Gear Shafts are their Associated Secondary Arms on which are mounted their Associated Quad Work Tool (41.4) Assemblies.

The Variant C with Single Secondary Motor (41.2) and Quad Work Tools, each Work Tool Designated to a Predetermined Quadrant, allows for Simultaneous Working on 4 Jobs, each one Located in its Designated Quadrant. This will not only increase Productivity by 4 Times as compared to a Single Secondary Motor covering all the 4 Quadrants.

The Variant C is more Simpler in Construction, yields Better Balance, Higher Efficiency and Higher Economy than Variant A since it eliminates the necessity of additional 3 Secondary Motors, 3 Secondary Motor Controller-Cum-Drivers and 3 Secondary Homing Sensors while yielding the same results.

Variant D: One can also arrive at other Variants of KPACS for Customised Applications. For example, Variant D in which the Distance between the Axis of Rotation of the Secondary Motor Shaft and the Axis of the Work Tool, representing the Magnitude of Secondary Kinetic Force equal to mS, is not equal to (as in the Theoretical Model) but less than the Distance between the Axis of Rotation of the Primary Motor Shaft and the Axis of Rotation of the Secondary Motor Shaft, representing the Magnitude of Primary Kinetic Force equal tomP, the Magnitude of Primary Kinetic Force.

Variant D also works based on the Theoretical Model of 2-Dimensional KPACS where mS<mP, but its Work Area is not equal to the Area of the Circular Boundary of 2-Dimensional KPACS, but only a part of it.

### Physical Model of 3-Dimensional KPACPS

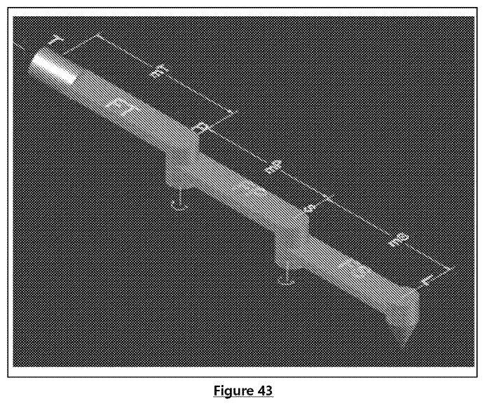

FIG. 43 illustrates a Simple Physical Model of the 3-Dimensional KPACPS which is modelled by integrating the 3rd Dimensional Kinetic Pole T and its Kinetic Forces and the effects of these Kinetic Forces with the Physical Model of the 2-Dimensional KPACPS to Function like the 3-Dimensional KPACPS:

The Primary Kinetic Pole P is modelled as a Shaft which is capable of Bi-Directional Rotation about its Axis which is Perpendicular to the Plane of 2-Dimensional KPACPS

The Secondary Kinetic Pole S is modelled as a Shaft which is capable of Bi-Directional Rotation about its Axis which is Perpendicular to the Plane of 2-Dimensional KPACPS

The Tertiary Kinetic Pole T is modelled as a Shaft which is capable of Bi-Directional Rotation about its Axis which is parallel to the Plane of 2-Dimensional KPACPS and Perpendicular to the Primary Kinetic Pole Axis and the Secondary Kinetic Pole Axis

The Locus L is modelled as Conical Shaft, whose Axis is Perpendicular to the Plane of 2-Dimensional KPACPS

The Primary Kinetic Force FP is modelled as the Primary Kinetic Arm Extending from the Primary Kinetic Pole and Binding the Secondary Kinetic Pole to the Primary Kinetic

Pole. The Magnitude of the Primary Kinetic Force, mP is Modelled as the Length of the Primary Kinetic Arm

The Secondary Kinetic Force FS is modelled as the Secondary Kinetic Arm Extending from the Secondary Kinetic Pole and Binding the Locus L to the Secondary Kinetic Pole. The Magnitude of the Secondary Kinetic Force, mS is Modelled as the Length of the Secondary Kinetic Arm such that the Length of Primary Kinetic Arm is equal to the Length of Secondary Kinetic Arm.

The Tertiary Kinetic Force FT is modelled as the Tertiary Kinetic Arm Extending from the Tertiary Kinetic Pole and Binding the Primary Kinetic Pole to the Tertiary Kinetic Pole. The Magnitude of the Tertiary Kinetic Force, mT is modelled as the Length of the Tertiary Kinetic Arm such that the Length of Tertiary Kinetic Arm is equal to the Length of the Primary Kinetic Arm, which is equal to the Length of Secondary Kinetic Arm.

When the Tertiary Kinetic Pole Rotates around its Rotational Axis, it results in the 2-Dimensional KPACS also Rotating about its 0°, making the Entire Plane of the 2-Dimensional KPACPS to tilt about its 0° by the same angle as the Angular Position of the Tertiary Kinetic Pole.

### Practical Model of 3-Dimensional KPACPS

A Typical Practical Model of the 3-Dimensional KPACPS is derived by Integrating the Tertiary Sub-System with the Typical Practical Model of the 2-Dimensional KPACPS.

In a Typical Practical Model of the 3-Dimensional KPACPS, the Tertiary Kinetic Pole T of the Theoretical and Physical Models of the 3-Dimensional KPACPS would be replaced by a suitable Electric Motor called the Tertiary Motor, which can be either a Stepper Motor or a Servo Motor, the Tertiary Kinetic Force FT is replaced by a suitable Metal Arm called the Tertiary Arm.

The Tertiary Arm is mounted Laterally On and Along the Axis of the Shaft of the Tertiary Motor so that as the Tertiary Motor Shaft rotates, the Tertiary Arm too rotates along the Axis of Rotation of the Tertiary Motor Shaft. The Tertiary Arm is integrated to the 2-Dimensional KPACPS such that as the Tertiary Motor Shaft and the Tertiary Arm rotate together, the entire 2-Dimensional KPACPS too rotates about the Axis of Rotation of the Tertiary Motor Shaft. Fastening of the Tertiary Arm to the Base Plate is carried out in a way such that the Tertiary Motor lies outside the Sphere formed by the resulting 3-Dimensional KPACPS. It is clear that as the Tertiary Motor Shaft turns, the 2-Dimensional KPACS also turns by an angle, which is equal to the Angular Position αT.

Thus, Integration of the Tertiary Sub-System with the Typical Practical Model of the 2-Dimensional KPACPS results in a Typical Practical Model of the 3-Dimensional KPACPS.

### APPENDIX-A

### Proof of 2-Dimensional KPACS

To prove that the 2-Dimensional KPACS is a Co-ordinates System in which the Location of every Point-On-A-Plane within its Circular Boundary is expressed by the Angular Pair (αP,αS).

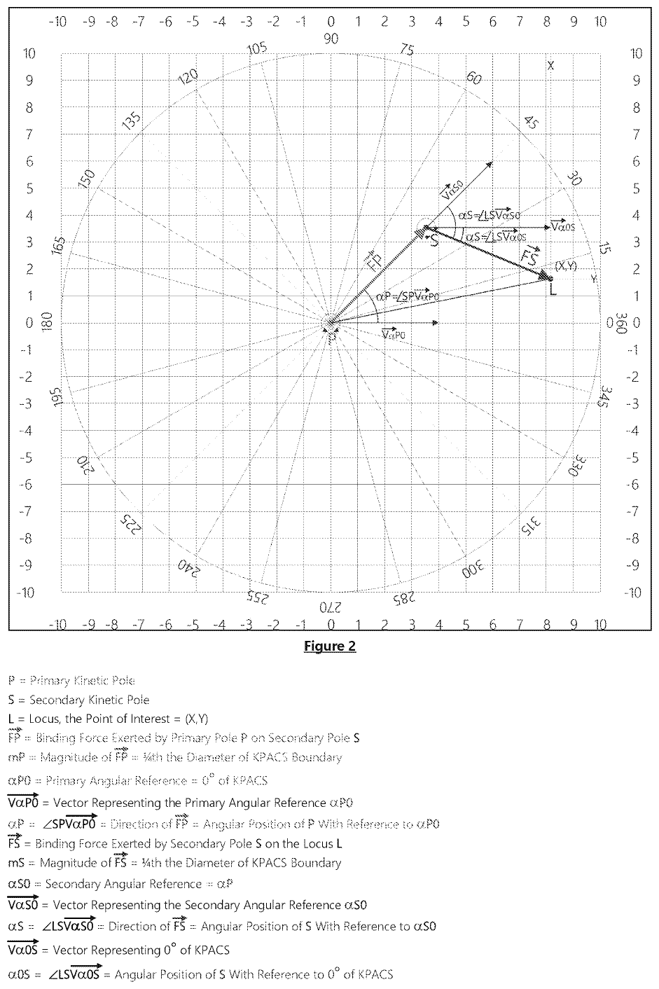

FIG. 2 illustrates the 2-Dimensional KPACS superimposed on a 2-Dimensional Cartesian Co-ordinates System with a Linear Grid. To arrive at the desired proof, it is sufficient to prove that the location of the Locus L expressed by the Cartesian Co-ordinate Pair (x, y) can also be expressed by the Angular Pair (αP,αS) as under:

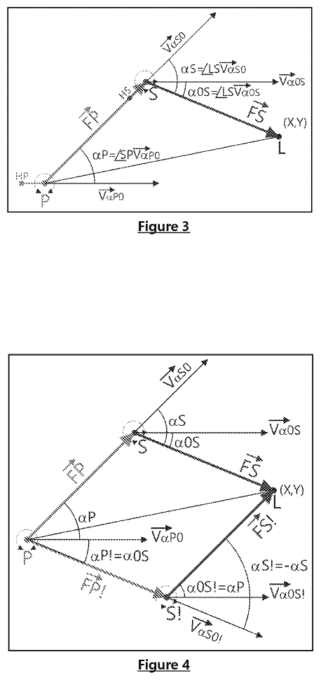

FIG. 3 is essentially the Active Block of FIG. 2 for easy assimilation. Referring to FIG. 3, we have the following:

Given:

Magnitude of FP (=mP)=1/4^{th} the Diameter of Circular Boundary of 2-Dimensional KPACS

Magnitude of FS (=mS)=1/4^{th} the Diameter of Circular Boundary of 2-Dimensional KPACS

Locus L expressed as Cartesian Co-ordinate Pair (x, y)

Observations:

It is observed from FIG. 3 (as well as FIG. 2) that:

$$α P = ∠ S P L + ∠ LPV α P 0$$

$$α S = ∠ L S V α S 0$$

Derivations:

It is essential to derive equations for ∠SPL, ∠PSL and ∠LPVαP0 in terms of known parameters to find αP and αS as under:

It is essential to find the Angle of (x,y) with reference to 0° as under:

$$∠ LPV α P 0 = {tan 2}^{- 1} ( y , x )$$

$${tan 2}^{- 1} ( y , x ) = ( sgn {( x )}^{2} * {tan}^{- 1} ( y / x ) ) + ( ( 1 sgn ( x ) ) / 2 ) * ( 1 + sgn ( y ) - sgn {( y )}^{2} ) * π$$

By applying Pythagoras Theorem, PL is derived as under:

$$PL = √ ( {x}^{2} + {y}^{2} )$$

By applying Law of cosines to ΔSPL, ∠SPL and ∠PSL are derived as under.

$$cos ( ∠ SPL ) = ( {mP}^{2} + {PL}^{2} - {mS}^{2} ) / ( 2 * mP * PL )$$

$$∴ ∠ SPL = {cos}^{- 1} ( ( {mP}^{2} + P {L}^{2} - {mS}^{2} ) / ( 2 * mP * PL ) )$$

Replacing the above derivations in the equation for αP, αP is resolved as under:

$$α P = {cos}^{- 1} ( ( {mP}^{2} + {PL}^{2} - {mS}^{2} ) / ( 2 * mP * PL ) ) + tan {2}^{- 1} ( y , x )$$

To resolve αS, consider the ΔSPL as under:

Given that mP=mS, ΔSPL is an Isosceles Triangle and by its Property, we have:

$$∠ SPL = ∠ SLP$$

By the Property of a Triangle, since it's Total Angle is 180°, we have:

$$∠ PSL = 180 - ( ∠ SPL + ∠ SLP )$$

Further, since ∠PSVαS0=180°, we have:

$$∠ LPV α S 0 = 180 - ∠ PSL$$

$$∴ ∠ LPV α S 0 = 180 - ( 180 - ( ∠ SPL + ∠ SLP ) ) = - ( ∠ SPL + ∠ SLP )$$

Replacing the above derivation in the equation for αS, αS is resolved as under:

$$α S = ∠ LPV α S 0 = - ( ∠ SPL + ∠ SLP )$$

Thus proved that the 2-Dimensional KPACS is a Co-ordinates System in which the Location of every Point-On-A-Plane within its Circular Boundary is expressed by the Angular Pair (αP,αS).

### Examples Of 2-Dimensional KPACS

FIG. 5 to FIG. 8 illustrate examples of 2-Dimensional KPACS in the 1^{st}, 2^{nd}, 3^{rd} and 4^{th} Quadrants of 2-Dimensional Cartesian Co-ordinates System respectively to show that any Point expressed as (x,y) using the Cartesian Co-ordinates or expressed as (r, φ) using the Polar Co-ordinates can also be expressed as Angular Pair (αP,aS) using 2-Dimensional Kinetic Poles Angular Co-ordinates System.

### Example 1

FIG. 5 illustrates Locus L of 2-Dimensional KPACS located in the 1^{st} Quadrant of the 2-Dimensional Cartesian Co-ordinates System. Referring to FIG. 5, we have the following:

Given:

mP=mS=5

Locus L=(x,y)=(8.1577,1.6288)

Computations:

We have: ∠LPVαP0=tan2⁻¹(y,x)=tan2⁻¹(1.6288,8.1577)

We have: tan2⁻¹(y,x)=(sgn(x)²*tan⁻¹ (y/x)+((1−sgn(x))/2)*(1+sgn(y)−sgn(y)²)*π

∴∠LPVαP0=(+(8.1577)²*tan⁻¹ (1.6288/8.1577)+((1−(+8.1577)/²)*(1+(+1.6288)−(+(1.6288)²)*π

∴∠LPVαP0==11.291°

We have: PL=√(x²+y²)

∴∠PL=√(8.1577) 2+(1.6288)²)

∴∠PL=8.3187

We have: 2SPL=cos⁻¹(mP²+PL²−mS²)/(2*mP*PL))=cos⁻¹(0.83187)

∴∠SPL=cos⁻¹(5²+(8.3187)²−5²)/(2*5*8.3187))

∴∠SPL=33.709°

Given that mP=mS, ΔSPL is an Isosceles Triangle and by its Property, we have:

$$∠ SLP = ∠ SPL = 33.709 °$$

Replacing the Computed Values in the Equations for αP, αS, αP! and αS!, we have:

$$α P = ∠ SPL + ∠ PSV α P 0 = 33.709 + 11.291 = 45 ° \\ α S = ∠ LPV α S 0 = - ( ∠ SPL + ∠ SLP ) = - ( 33.709 + 33.709 ) = - 67.418 ° \\ α 0 S = ∠ LPV α P 0 - ∠ SPL = ( 11.291 - 33.709 ) = - 22.418 ° \\ α P != α 0 S = - 22.418 ° \\ α S != - α S = 67.416 °$$

∠ Angular Co-ordinates (αP,αS)=) (45.0000,−67.416° of Point L corresponds to Cartesian Co-ordinates (x,y)=8.1577,1.6288) of the same Point L.

### Example 2

FIG. 6 illustrates Locus L of 2-Dimensional KPACS located in the 2^{nd} Quadrant of the 2-Dimensional Cartesian Co-ordinates System. Referring to FIG. 6, we have the following:

Given:

mP=mS=5

Locus L=(x,y)=(-3.3839,4.2404)

Computations:

We have: ∠LPVαP0=tan2⁻¹(y,x)=tan2⁻¹(4.2404,−3.3839)

We have: tan2⁻¹(y,x)=(sgn(x)²*tan⁻¹ (y/x)+((1−sgn(x))/²)*(1+sgn(y)−sgn(y)²)*π

∴∠LPVαP0=(−(−3.3839)²*tan⁻¹ (4.2404/−3.3839)+((1−(−0.3839))/2)*(1+(+4.2404)−(+(+4.2404)²)* π

∴∠LPVαP0==128.5903°

We have: PL=√(x²+y²)

∴∠PL=√(−3.3839)²+(4.2404)²)

∴∠PL=5.4251

We have: 2SPL=cos⁻¹(mP²+PL²−mS²)/(2*mP*PL))=cos⁻¹(0.83187)

∴∠SPL=cos⁻¹(5²+(5.4251)²−5²)/(2*5*5.4251)

∴∠SPL=57.1453°

Given that mP=mS, ΔSPL is an Isosceles Triangle and by its Property, we have:

$$∠ SLP = ∠ SPL = 57.1453 °$$

Replacing the Computed Values in the Equations for αP, αS, αP! and αS!, we have:

$$α P = ∠ SPL + ∠ PSV α P 0 = 58.1453 + 128.5903 = 184.736 ° \\ α S = ∠ LPV α S 0 = - ( ∠ SPL + ∠ SLP ) = - ( 57.1453 + 57.1453 ) = - 114.291 ° \\ α 0 S = ∠ LPV α P0 - ∠ SPL = ( 128.5903 - 57.1453 ) = 71.445 ° \\ α P != α 0 S = 71.445 ° \\ α S != - α S = 114.291 °$$

∴ Angular Co-ordinates (αP,αS)=(185.736°,−114.291°) of Point L corresponds to Cartesian Co-ordinates (x,y)=(−3.3839,4.2404) of the same Point L.

### Example 3

FIG. 7 illustrates Locus L of 2-Dimensional KPACS located in the 3rd Quadrant of the 2-Dimensional Cartesian Co-ordinates System. Referring to FIG. 7, we have the following:

Given:

mP=mS=5

Locus L=(x,y)=(−5.5287,−7.4162)

Computations:

We have: ∠LPVαP0=tan2⁻¹(y,x)=tan2⁻¹(−7.4162,−5.5287)

We have: tan2⁻¹(y,x)=(sgn(x)²*tan⁻¹ (y/x)+((1−sgn(x))/2)*(1+sgn(y)−sgn(y)²)*π

∴∠LPVαP0=(−(−5.5287)²*tan⁻¹ (−7.4162/-5.5287)+((1-(−5.5287))/2)*(1+(−7.4162)−(−(−7.4162)²)*π

∴∠LPVαP0==-126.7041°

We have: PL=√(x²+y²)

∴∠PL=√(−5.5287)²+(−7.4162)²)

∴∠PL=9.2502

We have: 2SPL=cos⁻¹(mP²+PL²−mS²)/(2*mP*PL)=cos⁻¹(0.83187)

∴∠SPL=cos⁻¹(5²+(9.2502)²−5²)/(2*5*9.2502))

∴∠SPL=22.3283°

Given that mP=mS, ΔSPL is an Isosceles Triangle and by its Property, we have:

$$∠ SLP = ∠ SPL = 22.3283 °$$

Replacing the Computed Values in the Equations for αP, αS, αP! and αS!, we have:

$$α P = ∠ SPL + ∠ PSV α P 0 = 22.3283 - 126.7041 = - 104.376 ° \\ α S = ∠ LPV α S 0 = - ( ∠ SPL + ∠ SLP ) = - ( 22.3283 + 22.3283 ) = - 44.657 ° \\ α 0 S = ∠ LPV α P 0 - ∠ SPL = ( - 126.7041 - 22.3283 ) = - 149.032 ° \\ α P != α 0 S = - 149.032 ° \\ α S != - α S = - 44.657 °$$

∴ Angular Co-ordinates (xP, (S)=) (−104.3760,−44.657° of Point L corresponds to Cartesian Co-ordinates (x,y)=(−5.5287,−7.4162) of the same Point L.

### Example 4

FIG. 8 illustrates Locus L of 2-Dimensional KPACS located in the 4^{th} Quadrant of the 2-Dimensional Cartesian Co-ordinates System. Referring to FIG. 8, we have the following:

Given:

mP=mS=5

Locus L=(x,y)=(6.826,−7.2140)

Computations:

We have: ∠LPVαP0=tan2⁻¹(y,x)=tan2⁻¹(−7.4162,−5.5287)

We have: tan2⁻¹(y,x)=(sgn(x)²*tan⁻¹ (y/x)+((1−sgn(x))/2)*(1+sgn(y)−sgn(y)²)*π

∴∠LPVαP0=(+(6.826)²*tan⁻¹ (−7.2140/6.826)+((1-(6.826)/2)*(1+(−7.2140)−(−(−7.4162)²)π

∴∠LPVαP0==−46.5830°

We have: PL=√(x²+y²)

∴PL=√(6.826)²+(−7.2140)²)

∴PL=9.9316

We have: 2SPL=cos⁻¹(mP²+PL²−mS²)/(2*mP*PL)=cos⁻¹(0.83187)

∴∠SPL=cos⁻¹(5²+(9.9316)²−5²)/(2*5*9.9316))

∴∠SPL=22.3283°

Given that mP=mS, ΔSPL is an Isosceles Triangle and by its Property, we have:

$$∠ SLP = ∠ SPL = 6.7067 °$$

Replacing the Computed Values in the Equations for αP, αS, αP! and αS!, we have:

$$α P = ∠ SPL + ∠ PSV α P 0 = 6.7067 - 46.583 = - 39.876 ° \\ α S = ∠ LPV α S 0 = - ( ∠ SPL + ∠ SLP ) = - ( 6.7067 + 6.7067 ) = - 13.413 ° \\ α 0 S = ∠ LPV α P 0 - ∠ SPL = ( - 46.583 - 6.7067 ) = - 53.29 ° \\ α P != α 0 S = - 53.29 ° \\ α S != - α S = 13.413 °$$

∴ Angular Co-ordinates (αP,αS)=(−39.876°,−13.413°) of Point L corresponds to Cartesian Co-ordinates (x,y)=(6.826,−7.2140) of the same Point L.

Alternate Angular Pairs In 2-Dimensional KPACS

FIG. 9 to FIG. 12 illustrate the Alternate Angular Pairs for the above Example 1 to Example 4 of the 2-Dimensional KPACS.

FIG. 9 illustrates the Alternate Angular Pair Symmetrical along the Line PL for the earlier Example 1 of FIG. 5 where we have:

$$α P = 45 ° \\ α S = - 67.418 ° \\ α P != α 0 S = - 22.418 ° \\ α S != - α S = 67.416 °$$

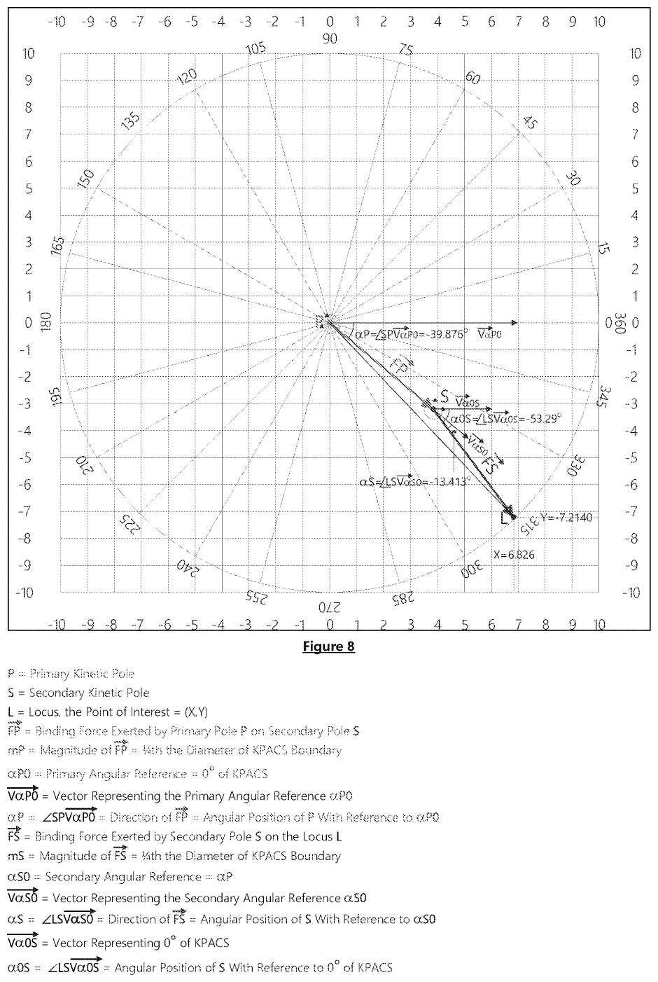

FIG. 10 illustrates the Alternate Angular Pair Symmetrical along the Line PL for the earlier Example 2 of FIG. 6 where we have:

$$α P = 185.736 ° \\ α S = - 114.291 ° \\ α P != α 0 S = 71.445 ° \\ α S != - α S = 114.291 °$$

FIG. 11 illustrates the Alternate Angular Pair Symmetrical along the Line PL for the earlier Example 3 of FIG. 7 where we have:

$$α P = - 104.376 ° \\ α S = - 44.657 ° \\ α P != α 0 S = - 149.032 ° \\ α S != - α S = - 44.657 °$$

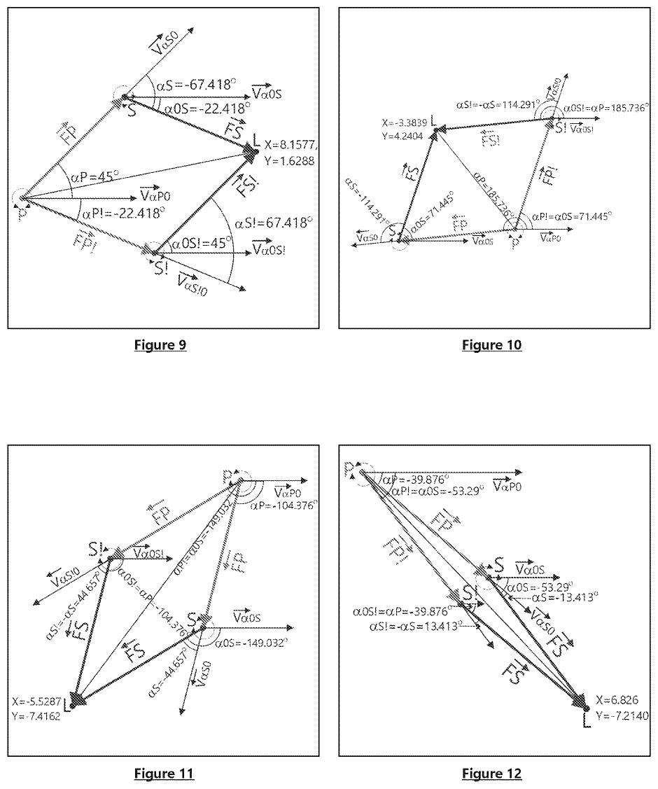

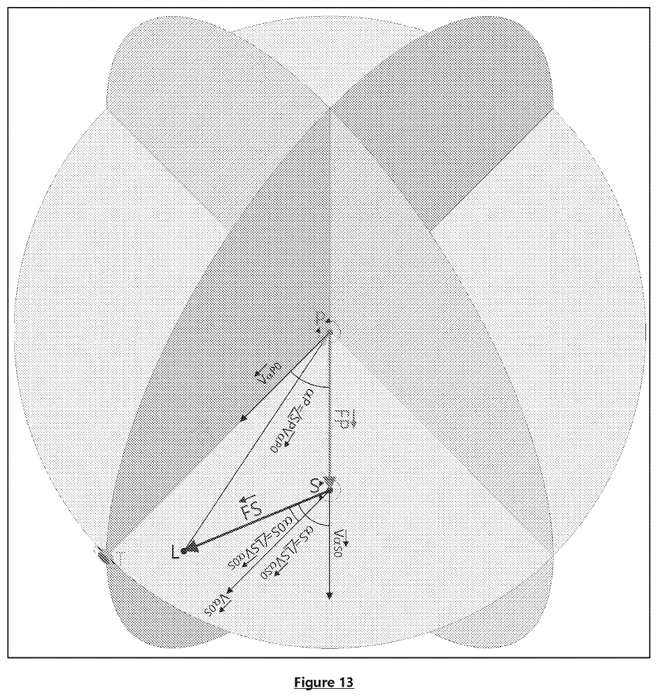

FIG. 12 illustrates the Alternate Angular Pair Symmetrical along the Line PL for the earlier Example 4 of FIG. 8 where we have:

$$α P = - 39.876 ° \\ α S = - 13.413 ° \\ α P != α 0 S = - 53.29 ° \\ α S != - α S = 13.413 °$$

### APPENDIX-B

### Proof of 3-Dimensional KPACS

To prove that the 3-Dimensional KPACS is a Co-ordinates System in which the Location of every Point in a Space within its Spherical Boundary is expressed by an Angular Set (αP, αS, αT).

FIG. 14 illustrates the First Quadrant of the 3-Dimensional KPACS with 2 Loci, L2D denoting the Location of L on the 2-Dimensional KPACS with (X,Y) being its Co-ordinates on the 2-Dimensional Cartesian Co-ordinates System and L3D denoting the Location of L on the 3-Dimensional KPACS with (X,Y.Z) being its Co-ordinates on the 3-Dimensional Cartesian Co-ordinates System. The Angular Position αP of the Primary Kinetic Pole and the Angular Position αS of the Secondary Kinetic Pole are set such that the Locus L2D can be expressed by the Angular Pair (αP, αS)=Cartesian Co-ordinates (X,Y) as proved under 2-Dimensional KPACS.

To attain the Locus L3D having (X, Y, Z) as its Co-ordinates in the 3-Dimensoanl Cartesian Co-ordinates System, the Angular Position αT of the Tertiary Kinetic Pole T will have to be set to an appropriate value which is derived as under:

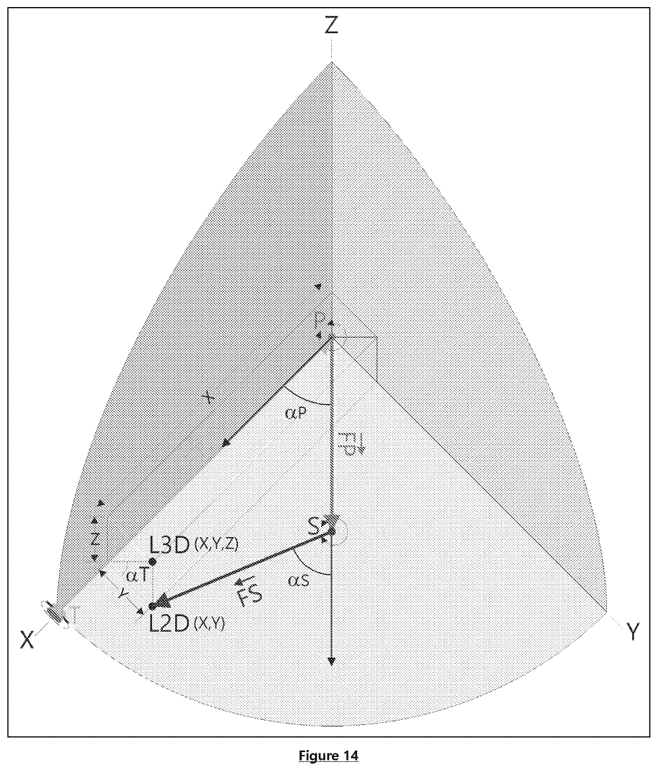

From FIG. 15, consider the Right Angle Triangle formed by the 2 Loci L2D and L3D with the X Axis as shown. This is the same Triangle formed by the x, y and z Points. Hence, let this Triangle be denoted as ΔXYZ. We have the Following:

The Angular Position αT of the Tertiary Kinetic Pole T is derived as under:

$$α T = ∠ YXZ$$

By applying Pythagoras Theorem to ΔXYZ, we have side XZ as,

$$( XZ ) = √ ( {y}^{2} + {z}^{2} )$$

By applying Law of cosines to ΔXYZ, ∠YXZ is derived as under

$$cos ( ∠ YXZ ) = ( {( XZ )}^{2} + {Y}^{2} - {Z}^{2} ) / ( 2 * ( XZ ) * Y ) \\ ∴ α T = ∠ YXZ = {cos}^{- 1} ( ( {( XZ )}^{2} + {Y}^{2} - {Z}^{2} ) / ( 2 * ( XZ ) * Y ) )$$

∴ Proved that Angular Co-ordinates (αP, αS, αT)=of Locus L3D corresponds to its Cartesian Co-ordinates (x, y, z).

### Example Of 3-Dimensional KPACS

FIG. 15 illustrates how the 2-Dimensional KPACS Plane of the 3-Dimensional KPACS turns around its 0° by an Angle which is equal to αT, the Angular Position of the Tertiary Kinetic Pole T to attain the required z value and the Angular Position αP of the Primary Kinetic Pole P and the Angular Position αS of the Secondary Kinetic Pole S are set to attain position (x, y) such that the Locus L on the 3-Dimensional KPACS is expressed by the Angular Set (αP, αS, αT) corresponding to the 3-Dimensional Cartesian Co-ordinates (x, y,z). Referring to FIG. 41, we have the following:

Given:

(x, y, z)=(8.1577,1.6288,1.15)

Computations:

$$( XZ ) = √ ( {y}^{2} + {z}^{2} ) = 1.9939 \\ α T = ∠ YXZ = {cos}^{- 1} ( {( XZ )}^{2} + {Y}^{2} - {Z}^{2} ) / ( 2 * ( XZ ) * Y ) = {cos}^{- 1} ( 5.3061 / 6.4953 ) = {cos}^{- 1} ( 0.8169 ) = 35.223 ° \\ α P = 45 ° \\ α S = - 67.418 ° \\ α T = 35.223 °$$

∴ The Location of Locus L expressed by the Angular Set (αP, αS, αT) of the 3-Dimentional KPACS corresponds to (x, y, z) expressed by the 3-Dimensional Cartesian Co-ordinates.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. A 2-dimensional kinetic-poles angular co-ordinates positioning system (KPACPS) of FIG. 31 and FIG. 32, the said system realized from a 2-dimensional kinetic-poles angular co-ordinates system (KPACS), comprising of various appropriately arranged interconnected functional blocks namely, a machine frame block, a DC power block, an external interface block, a primary co-ordinate block, a secondary co-ordinate block, and a work tool assembly, wherein:
a) the machine frame block comprises a machine frame (31.17) and a top plate (31.16) suitably fastened to top of the machine frame;
b) the DC power block comprises a suitable DC power supply (31.19) suitably mounted on the top plate;
c) the external interface block comprises a command and data processor with a communication port (31.18) suitably mounted on the top plate;
d) the primary co-ordinate block comprises a primary motor (31.1) along with a primary motor shaft (31.3) suitably mounted at the center of the top plate and perpendicular to the KPACPS plane, a suitable primary motor controller-cum-driver (31.2) suitably mounted on the top plate, a primary optical homing sensor (31.4) suitably mounted on the top plate in such a manner that it is aligned to 0° of 2-dimensional KPACPS plane, a primary optical homing sensor interrupter (31.5) suitably mounted on the primary motor shaft, a primary slip ring (31.6) suitably mounted on the primary motor shaft, and a primary plate (31.7) suitably mounted at its center on the primary motor shaft;
e) the secondary co-ordinate block comprises a secondary motor (31.14) along with its secondary motor shaft (31.15) suitably mounted at the center of the primary plate and perpendicular to the KPACPS plane, a suitable secondary motor controller-cum-driver (31.13) suitably mounted on the primary plate, a secondary optical homing sensor (31.11) suitably mounted on the primary plate, a secondary optical homing sensor interrupter (31.12) suitably mounted on the secondary motor shaft, a secondary slip ring (31.6) suitably mounted on the secondary motor shaft, and a secondary arm (31.9) suitably mounted on the secondary motor shaft and perpendicular to the motor shaft; and
f) The work tool assembly (31.8) comprises a suitable work tool and work tool controller-cum-driver suitably mounted on the secondary arm such that the work tool is perpendicular to the 2-dimensional KPACPS plane;
wherein:
g) the DC power block whose ac input terminals are connected to an AC mains power and whose DC output terminals are connected to DC power wherein input terminals of the primary motor controller-cum-driver, the primary homing sensor, the external interface block, and the DC power terminals of the primary slip ring stator which extend to corresponding DC power terminals of the primary slip ring rotor and in turn connected to secondary DC power terminals of the secondary slip ring stator which extend to the corresponding DC power terminals of the secondary slip ring rotor, supplies the required DC power to static parts of the system and to rotating parts of the secondary co-ordinate block and the work tool assembly through the primary and secondary slip rings stators;
h) the primary motor shaft of the primary motor capable of bi-directional rotation such as a stepper motor or a servo motor is selected depending on the application requirements serves as the primary kinetic pole p of 2-dimensional KPACS and the primary motor shaft's bi-directional rotational motion serves as the bi-directional rotational motion of the primary kinetic pole p of 2-dimensional KPACS;
i) the primary motor controller-cum-driver is selected depending on the choice of the primary motor and connected to the primary motor for controlling the direction of rotation, angle of rotation, acceleration, and speed of rotation of the primary motor shaft whose angular position serves as a primary angular position ap of a primary kinetic pole p of the 2-dimensional KPACS;
j) the primary optical homing sensor connected to the primary motor controller-cum-driver provides the primary homing signal whenever it is interrupted by a primary optical homing sensor interrupter rotating along with the primary motor shaft thus enabling setting the angular position of the primary motor shaft to its homing position which represents the primary angular reference αp0=0° of the 2-dimensional KPACS;
k) the primary slip ring connected to the DC power supply and the primary motor controller-cum-driver enables extension of DC power, internal communication bus, and other signals to the secondary co-ordinate block and the work tool assembly;
I) the primary plate provides mechanical connectivity from the primary co-ordinate block to the secondary co-ordinate block so that it revolves around the rotating primary motor shaft which serves as the primary kinetic pole p of the 2-dimensional KPACS thereby serving as the primary kinetic force fp of the 2-dimensional KPACS;
m) the secondary motor shaft of the secondary motor capable of bi-directional rotation such as a stepper motor or a servo motor is selected depending on the application requirements serves as the secondary kinetic pole s of the 2-dimensional KPACS and the secondary motor shaft's bi-directional rotational motion serves as the bi-directional rotational motion of the secondary kinetic pole s of the 2-dimensional KPACS;
n) the secondary motor controller-cum-driver is selected depending on the choice of secondary motor and is connected to the secondary motor for controlling the direction of rotation, angle of rotation, acceleration, and speed of rotation of secondary motor shaft whose angular position serves as the secondary angular position as of the secondary kinetic pole s of the 2-dimensional KPACS;
o) the secondary optical homing sensor connected to the secondary motor controller-cum-driver provides the secondary homing signal whenever it is interrupted by the secondary optical homing sensor interrupter rotating along with the secondary motor shaft thus enabling setting the angular position of the secondary motor shaft to its homing position which represents the secondary angular reference αs0=0° of 2-dimensional KPACS;
p) the secondary slip ring connected to the DC power supply via the primary slip ring and the secondary motor controller-cum-driver enables extension of DC power, internal communication bus, and other signals to the work tool controller-cum-driver;
q) the secondary arm provides mechanical connectivity to the work tool so that it revolves around the rotating secondary motor shaft which serves as the secondary kinetic pole s of the 2-dimensional KPACS thereby serving as the secondary kinetic force fs of the 2-dimensional KPACS;
r) the work tool controller-cum-driver connected to the secondary slip ring drives the work tool, which serves as the locus L of the 2-dimensional KPACS, is mounted such that the axis of rotation of the primary motor shaft, the axis of rotation of the secondary motor shaft, and the axis of the work tool are parallel to each other and the axial distance between the axis of rotation of the primary motor shaft and the axis of rotation of the secondary motor shaft represents the magnitude mp of the primary kinetic force fp of the 2-dimensional KPACS and the axial distance between the axis of rotation of the secondary motor shaft and the axis of work tool represents the magnitude ms of the secondary kinetic force fs of the 2-dimensional KPACS;
s) the work area of the 2-dimensional KPACPS is defined by a circular plane-of-interest of radius=mp+ms and situated such that a tip of the work tool when activated, lies on the work area and is perpendicular to the axis of rotation of the primary motor shaft, the axis of rotation of the secondary motor shaft, and the axis of the work tool, and its center is on the axis of rotation of the primary motor shaft;
t) the primary motor controller-cum-driver and the secondary motor controller-cum-driver are connected to the internal communication bus for communicating with the external interface block for continuous synchronized operation of the primary motor, the secondary motor and the work tool essential while carrying out any given work; and
u) the command and data processor of the external interface block communicates through its communication port with an external command and data source such as a PLC or a CAD-CAM system to acquire and process vector data of a specific work and provide appropriate sequential commands and signals over the internal communication bus to other components of the 2-dimensional KPACPS connected on the internal communication bus for carrying out any given work.

13. A method of operation of the 2-dimensional KPACPS of claim 1 comprising the steps of:
a) upon power up, the system initializes by performing a sequence of tasks including,
i) the primary motor controller-cum-driver drives the primary motor such that the primary motor shaft rotates in a clockwise direction until the primary optical homing sensor interrupter interrupts the primary optical homing sensor thereby setting the primary motor shaft to its homing position,
ii) the secondary motor controller-cum-driver drives the secondary motor such that the secondary motor shaft rotates in a clockwise direction until the secondary optical homing sensor interrupter interrupts the secondary optical homing sensor thereby setting the secondary motor shaft to its homing position,
iii) the work tool controller-cum-driver drives the work tool to its idle position, and
iv) the command and data processor of the external interface block gets ready to connect to the external command and data source to receive cad-cam vector data for further action;
b) upon connecting and acquiring vector data specific to a work to be carried out from the external command and data source, the command and data processor compiles a series of commands and parameters, comprising of primary and secondary angular pairs (αp, αs), work tool state and other parameters such as acceleration and speed of primary and secondary motors corresponding to each vector data set of the received vector data;
c) upon compilation of series of commands and parameters for the specific work to be carried out, the command and data processor communicates each set of corresponding commands and parameters sequentially to the primary motor controller-cum-driver, the secondary motor controller-cum-driver, and the work tool controller-cum-driver; and
d) the primary motor controller-cum-driver, the secondary motor controller-cum-driver, and the work tool controller-cum-driver receive each set of commands and parameters and drive the primary motor, the secondary motor and the work tool to the corresponding angular positions (αp, αs) and work tool state synchronously until the intended work is completed.

14. The 2-dimensional KPACPS of claim 1, which is a 4-quadrant 2-dimensional KPACPS of FIG. 37 and FIG. 38, wherein:
a) the 4-quadrant KPACPS is derived by appropriately altering the construction of the KPACPS and is employed for carrying out four identical works simultaneously in a single KPACPS implementation;
b) the 4-quadrant KPACPS comprises a single common primary co-ordinate block and four secondary co-ordinate blocks and four work tool assemblies, each secondary co-ordinate block and the associated work tool assembly assigned to a designated quadrant of the circular work area of the KPACPS and aligned 90° apart from each other, thereby limiting the work area of each secondary co-ordinate block and its associated work tool assembly to its designated quadrant; and
c) while the common primary co-ordinate block simultaneously drives all the four secondary co-ordinate blocks and their associated work tool assemblies, each of the four identical works is carried out in its designated quadrant by the designated secondary co-ordinate block and the associated work tool assembly based on its designated commands and parameter sets received from the common command the data processor over the internal communication bus.

15. The 2-dimensional KPACPS of claim 3, which is a 4-quadrant geared 2-dimensional KPACPS of FIG. 39 and FIG. 40, wherein:
a) everything else remaining the same, the four secondary motors are replaced by a single common secondary motor mounted at the center of the primary plate aligned with the primary motor shaft and a suitable secondary gear train to achieve the same results as claim 3;
b) the secondary gear train comprises of five gears of equal dimensions and ratio of 1:1, each with a radius=1/2×mp, mp being the axial distance between the primary motor shaft and any of the secondary motor shafts of claim 3;
c) one of the five gears called the drive gear is mounted on the common secondary motor shaft, whereas the other four gears, called the driven gears are mounted on four shafts which are mounted on the primary plate 90° apart so as to mesh with the drive gear, thereby forming the four quadrants of claim 3;
d) each of the four secondary arms is mounted on each of the four driven gear shafts and the each of the four work tool assemblies is mounted on each of the four secondary arms so that each of the four work tool assemblies gets assigned to a designated quadrant of the circular work area of KPACPS and aligned 90° apart from each other similar to that of claim 3; and
e) the working is similar to that of claim 3 excepting that the common secondary motor drives the drive gear which in turn drives the four driven gears thereby achieving the same result as that of claim 3.

16. The 2-dimensional KPACPS of claim 1, which is an unequal 2-dimensional KPACPS, wherein:
a) everything else remaining the same, by design, the axial distance between the axis of secondary motor shaft and the axis of the work tool is smaller than the axial distance between the axis of the primary motor shaft and the axis of the secondary motor shaft depending on the application requirements; and
b) the work area is lesser by the inaccessible area of the circle with its center at the center of the 2-dimensional KPACS and radius which is the difference between the axial distance between the axis of the primary motor shaft and the axis of the secondary motor shaft and the axial distance between the axis of secondary motor shaft and the axis of the work tool.

17. The 2-dimensional KPACPS of claim 1, further comprising a 3^{rd} dimension so as to create a 3-dimensional KPACPS, wherein:
a) a tertiary co-ordinate block is appropriately integrated to the 2-dimensional KPACPS at 90° to the 2-dimensional KPACPS plane to derive the 3^{rd} dimension resulting in a spherical 3-dimensional KPACPS space;
b) the tertiary co-ordinate block comprises a tertiary motor along with its tertiary motor shaft suitably mounted, a suitable tertiary motor controller-cum-driver suitably mounted, a tertiary optical homing sensor suitably mounted and aligned to 0° of the 3rd dimension, a tertiary optical homing sensor interrupter suitably mounted on the tertiary motor shaft, a tertiary slip ring suitably mounted on the tertiary motor shaft, and a tertiary arm suitably mounted at its center on the tertiary motor shaft; and
c) the 3-dimensional KPACPS enables location of any point-in-space inside the spherical 3-dimensional KPACPS space.

18. A pen plotter of FIG. 35 and FIG. 36 used for plotting CAD drawings implemented based on the 2-dimensional KPACPS of claim 1, wherein the work tool is a plotter pen assembly (36.9) comprising a plotter pen holder (36.8), a plotter pen (36.10), a plotter pen actuator (36.12) which may be a digital servo motor or a solenoid actuator, and a suitable plotter pen controller-cum-driver (36.13), wherein operation of the plotter pen as to whether it is actuated or not actuated at any instant throughout plotting operation of a CAD drawing is controlled depending on the work tool state (up or down) for each command and parameter set derived from vector data of the CAD drawing acquired from an external source connected via the external interface block.

19. The 2-dimensional KPACPS of claim 1, in combination with a system selected from the group consisting of:
a) a positioning system used in manufacturing machines and medical equipment in various tasks for accurate tool positioning or part positioning such as XY-tables and medical scanners may be implemented based on the 2-dimensional KPACPS of claim 1, wherein operation of the positioning system is controlled depending on the work tool state for each of the command and parameter set derived from the vector data of the cad drawing acquired from an external source connected via the external interface block;
b) an industrial robotic system used for various 2D tasks in manufacturing may be implemented based on the 2-dimensional KPACPS of claim 1, wherein operation of the robotic system is controlled depending on the work tool state for each of the command and parameter set derived from the vector data of the cad drawing of the task acquired from an external source connected via the external interface block;
c) a recorder used in scientific and engineering applications for plotting 2D graphs of real time seismic activity and real time test data may be implemented based on the 2-dimensional KPACPS of claim 1, wherein operation of the recorder is controlled depending on the work tool state for each of the command and parameter set derived from the real time vector data acquired from an external source connected via the external interface block;
d) a 2D scanner used for scanning 2D documents implemented based on the 2-dimensional KPACPS of claim 1, wherein the work tool is a suitable scanning element and the scanned data received from the scanning element is transferred to an external device connected via the external interface block; and
e) a laser machine used in manufacturing such as laser marking, laser cutting and laser welding tasks implemented based on the 2-dimensional KPACPS of claim 1, wherein the work tool is a laser assembly comprising of suitable laser source and a laser source controller-cum-driver wherein operation of the laser source is controlled depending on the work tool state for each of the command and parameter set derived from the vector data of the cad drawing of the task acquired from an external source connected via the external interface block.

20. The 3-dimensional KPACPS of claim 6, in combination with a system selected from the group consisting of:
a) a positioning system used in manufacturing machines and medical equipment in various tasks for accurate tool positioning or part positioning such as XY-tables and medical scanners may be implemented based on the 3-dimensional KPACPS of claim 6, wherein operation of the positioning system is controlled depending on the work tool state for each of the command and parameter set derived from the vector data of the cad drawing acquired from an external source connected via the external interface block;
b) an industrial robotic system used for various 3D tasks in manufacturing implemented based on the 3-dimensional KPACPS of claim 6, wherein operation of the robotic system is controlled depending on the work tool state for each of the command and parameter set derived from the vector data of the cad drawing of the task acquired from an external source connected via the external interface block;
c) a 3D printer used in manufacturing of various components implemented based on the 3-dimensional KPACPS of claim 6, wherein operation of the 3D printer is controlled depending on the work tool state for each of the command and parameter set derived from the vector data of the cad drawing of the component acquired from an external source connected via the external interface block;
d) a 3D scanner used for scanning of 3D components in reverse engineering applications implemented based on the 3-dimensional KPACPS of claim 6, wherein the work tool is a suitable scanning element and the scanned data received from the scanning element is transferred to an external device connected via the external interface block; and
e) a laser machine used in manufacturing such as laser marking, laser cutting and laser welding tasks implemented based on the 3-dimensional KPACPS of claim 6, wherein the work tool is a laser assembly comprising of suitable laser source and a laser source controller-cum-driver wherein operation of the laser source is controlled depending on the work tool state for each of the command and parameter set derived from the vector data of the cad drawing of the task acquired from an external source connected via the external interface block.
